(19) United States
(12) Patent Application Publication
(10) Pub. No.: US 2026/0311263 A1
(43) Pub. Date: Oct. 8, 2026

(54) SYSTEM AND METHOD FOR DETERMINING OUTCOMES OF INSURANCE CLAIMS USING AGENTIC ARTIFICIAL INTELLIGENCE (AI) MODELS

(71) Applicant: Autonomize Inc., Austin, TX (US)

(72) Inventors: Lakshminarayanan Krishnamurthy, Austin, TX (US); Utkarsh Mujumdar, Austin, TX (US); Ganesh Padmanabhan, Austin, TX (US); Kris Nair, Austin, TX (US); Prithviraj Elangovan, Austin, TX (US)

(21) Appl. No.: 19/637,366

(22) Filed: Apr. 2, 2026

Related U.S. Application Data
(60) Provisional application No. 63/782,071, filed on Apr. 2, 2025.

(51) Int. Cl. G06Q 40/08

(52) U.S. Cl. CPC G06Q 40/09; G06Q 40/084

(57) ABSTRACT

A system and method for determining outcomes of insurance claims using of a plurality of agentic AI models are disclosed. The computer-implemented system receives input data corresponding to insurance claim from user. Further, the computer-implemented system extracts insurance-related data from input data using first Gen AI model. Furthermore, the computer-implemented system generate sequence of dynamically determined evaluation instructions for adjudicating insurance claim. Additionally, the computer-implemented system identify agentic AI models for executing sequence of dynamically determined evaluation instructions. Further, the computer-implemented system executes sequence of dynamically determined evaluation instructions by selectively applying sequence of dynamically determined evaluation instructions at identified agentic AI models. Furthermore, the computer-implemented system validates output of identified plurality of AI models. Additionally, the computer-implemented system determines actions for claim adjudication. Further, the computer-implemented system generate final claim result. Furthermore, the computer-implemented system outputs final claim result and explanation data corresponding to final result on user device.

### CROSS-REFERENCE TO RELATED APPLICATIONS

This application claims the benefit of the earlier-filed provisional application 63/782,071, filed on Apr. 02, 2025, entitled “ARTIFICIAL INTELLIGENCE-BASED SYSTEM AND METHOD FOR AUTOMATING CLAIM ADJUDICATION PROCESS,” the contents of which are incorporated herein by reference.

### TECHNICAL FIELD

This patent application is directed to data processing systems and, more specifically, to a system and a method for determining outcomes of insurance claims using a plurality of agentic Artificial Intelligence (AI) models.

### BACKGROUND

Generally, an insurance claim adjudication, particularly a health insurance claim adjudication, is a critical process in a healthcare administration. The insurance claim adjudication provides that a plurality of submitted insurance claims comply with one or more policy guidelines prior to at least one of approval and/or denial. Further, a traditional adjudication method may rely heavily on a manual review for evaluating one or more claim details. Furthermore, the traditional adjudication method may rely on matching the one or more claim details with one or more corresponding insurance policy documents, and determining claim validity.

In addition, a plurality of traditional adjudication method are time-consuming, error-prone, and often inconsistent due to a plurality of variations in a human judgment. Further, the one or more corresponding insurance policy documents include one or more complex clauses, one or more exclusions, and one or more conditions. The one or more complex clauses, one or more exclusions, and one or more conditions are difficult to accurately interpret, thereby leading to disputes and inefficiencies in claim processing. Additionally, an increasing volume of one or more insurance claims further exacerbates inefficiencies in claim processing, thereby necessitating a more automated and intelligent approach.

Moreover, a plurality of prior art systems attempt to automate one or more portions of a claim adjudication process. However, the plurality of prior art systems have significant limitations. Further, one or more rule based expert systems are utilized to encode the one or more policy guidelines into at least one of one or more decision tree models and one or more logic based models. The one or more decision tree models and the one or more logic based models are configured for processing at least one of medical data and supporting decision making. However, the one or more rule-based expert systems are unable to effectively adapt to evolving policies and require frequent manual updates to incorporate a plurality of new regulations. Further, one or more traditional Optical Character Recognition (OCR) based systems may extract a textual data from the one or more corresponding insurance policy documents. However, the one or more traditional OCR based systems lack contextual understanding and reasoning capability, thereby limiting an effectiveness for one or more decision-making processes. Consequently, the plurality of prior art systems are unable to address a complexity associated with a policy interpretation, thereby leading to misclassification of the one or more insurance claims and an increased reliance on a manual intervention.

Additionally, recent advancements in one or more Artificial Intelligence (AI) based systems have introduced one or more machine learning-based models for processing of the one or more insurance claims. Further, the one or more Artificial Intelligence (AI) based systems utilize one or more Natural Language Processing (NLP) models to extract relevant information from the one or more insurance claims. Furthermore, the one or more AI based systems may match the extracted relevant information with the one or more policy guidelines. However, the one or more AI based systems lack advanced reasoning capabilities. Further, the one or more AI based systems may be unable to handle one or more ambiguous scenarios. Furthermore, in the one or more ambiguous scenarios a plurality of policy conditions may be applied. Additionally, the one or more AI based systems may not provide one or more transparent explanations corresponding to one or more claim adjudication decisions. Further, the one or more AI based systems may thereby limit at least one of an interpretability and a verifiability for one or more users.

Furthermore, one or more traditional claim adjudication methods involve a significant manual intervention, which may result in inefficiencies, inconsistencies, and errors. The one or more corresponding insurance policy documents are comprehensive in nature. Further, the one or more corresponding insurance policy documents remain underutilized in a plurality of automated adjudication processes. Accordingly, there remains a need for an intelligent and adaptive system capable of effectively utilizing the one or more corresponding insurance policy documents for at least one of an accurate claim adjudication, a consistent claim adjudication, and a transparent claim adjudication.

Consequently, there is a need for improved a system and a method for determining outcomes of insurance claims using a plurality of agentic Artificial Intelligence (AI) models, which may be capable of minimizing a human intervention, enhancing consistency, and providing transparent explanations for claim adjudication outcomes and to address at least the aforementioned issues in the prior arts.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure may provide a computer-implemented system for determining outcomes of insurance claims using a plurality of agentic Artificial Intelligence (AI) models. The computer-implemented system may receive input data corresponding to an insurance claim from at least one user via a user interface of a user device. The input data may include at least one of claim data, claimant attributes, provider information, and one or more insurance policy documents. Further, the computer-implemented system may extract insurance-related data from the input data using a first Generative Artificial Intelligence (Gen AI) model. The extracted insurance-related data may include at least one of structured claim attributes and unstructured claim attributes. The extracted insurance-related data may include at least one of diagnosis codes, procedure codes, treatment descriptions, and contextual claim attributes. Furthermore, the computer-implemented system may generate, using a reasoning agent including a Gen AI model, a sequence of dynamically determined evaluation instructions for adjudicating the insurance claim. The sequence of dynamically determined evaluation instructions for adjudicating the insurance claim may be generated based on one or more contextually relevant policy sections and the extracted insurance-related data. Each of the dynamically determined evaluation instructions may correspond to a policy interpretation step obtained from the one or more contextually relevant policy sections of the one or more insurance policy documents. In addition, the computer-implemented system may identify a plurality of agentic Artificial Intelligence (AI) models for executing the sequence of the dynamically determined evaluation instructions. The plurality of agentic AI models may include at least of a data extraction agent, a policy evaluation agent, and the reasoning agent. Further, the computer-implemented system may execute the sequence of dynamically determined evaluation instructions by selectively applying the sequence of the dynamically determined evaluation instructions at the identified plurality of agentic AI models. Furthermore, the computer-implemented system may validate an output of the identified plurality of AI models based on execution of the sequence of the dynamically determined evaluation instructions at the identified plurality of agentic AI models. In addition, the computer-implemented system may determine one or more actions for claim adjudication using a stepwise reasoning path model and results of validation. The one or more actions may include retrieving additional claim data, generating external application programming interfaces (APIs), and refining a policy evaluation. Further, the computer-implemented system may generate a final claim result based on the stepwise reasoning path model and the determined one or more actions. Furthermore, the computer-implemented system may output the final claim result and an explanation data corresponding to the final result on the user interface of the user device. The explanation data may include at least one of references to the one or more insurance policy documents and the stepwise reasoning path model.

Another aspect of the present disclosure may provide a method for determining outcomes of insurance claims using a plurality of agentic Artificial Intelligence (AI) models. The method may include receiving input data corresponding to an insurance claim from at least one user via a user interface of a user device. The input data may include at least one of claim data, claimant attributes, provider information, and one or more insurance policy documents. Further, the method may include extracting insurance-related data from the input data using a first generative Artificial Intelligence (AI) model. The extracted insurance-related data may include at least one of structured claim attributes and unstructured claim attributes. The extracted insurance-related data may include at least one of diagnosis codes, procedure codes, treatment descriptions, and contextual claim attributes. Furthermore, the method may include generating using a reasoning agent including a generative artificial intelligence model, a sequence of dynamically determined evaluation instructions for adjudicating the insurance claim, based on one or more contextually relevant policy sections and the extracted insurance-related data. Each of the dynamically determined evaluation instructions may correspond to a policy interpretation step obtained from the one or more contextually relevant policy sections of the one or more insurance policy documents. In addition, the method may include identifying a plurality of agentic artificial intelligence models for executing the sequence of the dynamically determined evaluation instructions. The plurality of agentic artificial intelligence models may include at least one of a data extraction agent, a policy evaluation agent, and the reasoning agent. Further, the method may include executing the sequence of dynamically determined evaluation instructions by selectively applying the sequence of the dynamically determined evaluation instructions at identified plurality of agentic artificial intelligence models. Furthermore, the method may include validating an output of the identified plurality of AI models based on execution of the sequence of the dynamically determined evaluation instructions at the identified plurality of agentic AI models. In addition, the method may include determining one or more actions for claim adjudication using a stepwise reasoning path model and results of validation. The one or more actions may include retrieving additional claim data, generating external application programming interfaces, and refining a policy evaluation. Further, the method may include generating a final claim result based on the stepwise reasoning path and the determined one or more actions. Furthermore, the method may include outputting the final claim result and explanation data corresponding to the final result on the user interface of the user device. The explanation data may include at least one of references to the one or more insurance policy documents and the stepwise reasoning path model.

To further clarify the features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

Features of the disclosed embodiments are illustrated by way of example and not limited in the following Figure(s), in which like numerals indicate like elements, in which:

FIG. 1 illustrates an example block diagram representation of a network architecture for a computer-implemented system for determining outcomes of insurance claims using a plurality of agentic Artificial Intelligence (AI) models, according to an example;

FIG. 2 illustrates an exemplary block diagram representation of an operational configuration of the computer-implemented system as shown in FIG. 1 for determining the outcomes of the insurance claims, according to an example;

FIG. 3 illustrates an exemplary schematic representation of a system architecture of the computer-implemented system, according to an embodiment of the present invention, according to an example;

FIGS. 4A-4C illustrate exemplary schematic diagram representations depicting operational configurations of the computer-implemented system for generating the final claim result and the explanation data for the insurance claim, according to an example;

FIGS. 5A-5G illustrate exemplary schematic diagram representations depicting operational configurations of the computer-implemented system for determining the final claim result and the explanation data for the insurance claim, according to an embodiment of the present invention;

FIG. 6 illustrates an example block diagram representation of a hardware platform for implementation of a computer system, according to an example; and

FIG. 7 illustrates an example flow diagram representation of a method for determining outcomes of insurance claims using the plurality of agentic Artificial Intelligence (AI) models, according to an example.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the examples of the present disclosure so as not to obscure the figures with details that will be readily apparent to those skilled in the art having the benefit of the description herein.

### DETAILED DESCRIPTION

For simplicity and illustrative purposes, the proposed approach and solutions are described by referring mainly to examples and embodiments thereof. In the following description, numerous specific details are set forth in order to provide a thorough understanding of the proposed approach and solutions. It will be readily apparent, however, that the proposed approach and solutions may be practiced without limitation to these specific details. In other instances, some methods and structures readily understood by one of ordinary skill in the art have not been described in detail so as not to unnecessarily obscure the ongoing description. As used herein, the terms "a" and "an" are intended to denote at least one of a particular element, the term "includes" means includes but not limited to, the term "including" means including but not limited to, and the term "based on" means based at least in part on, the term "based upon" means based at least in part upon, and the term "such as" means such as but not limited to. The term "relevant" means closely connected or appropriate to what is being performed or considered.

The terms "comprise", "comprising", or any other variations thereof, are intended to cover a non-exclusive inclusion, such that one or more devices or sub-systems or elements or structures or components preceded by "comprises... a" does not, without more constraints, preclude the existence of other devices, sub-systems, additional modules.

A computer system (standalone, client, or server computer system) configured by an application may constitute a "module" (or "subsystem") that is configured and operated to perform certain operations. In one example, the "module" or "subsystem" may be implemented mechanically or electronically, so a module includes dedicated circuitry or logic that is permanently configured (within a special-purpose processor) to perform certain operations. In another example, a ""module" or "subsystem" may also comprise programmable logic or circuitry (as encompassed within a general-purpose processor or other programmable processor) that is temporarily configured by software to perform certain operations.

Accordingly, the term "module" or "subsystem" should be understood to encompass a tangible entity, be that an entity that is physically constructed permanently configured (hardwired) or temporarily configured (programmed) to operate in a certain manner and/or to perform certain operations described herein.

Unless otherwise defined, all technical and scientific terms used herein have the same meaning as commonly understood by those skilled in the art to which this disclosure belongs. The system, methods, and examples provided herein are only illustrative and not intended to be limiting.

A system and method for determining outcomes of insurance claims using a plurality of agentic Artificial Intelligence (AI) models. In the following description, for the purposes of explanation, numerous specific details are set forth to provide a thorough understanding of the present disclosure. It is apparent, however, that the present disclosure may be practiced without these specific details or with an equivalent arrangement. In other instances, well-known structures and devices are shown in block diagram form in order to avoid unnecessarily obscuring the present disclosure.

Examples of the present disclosure provide a computer-implemented system for determining outcomes of insurance claims using a plurality of agentic Artificial Intelligence (AI) models. The computer-implemented system may receive input data corresponding to an insurance claim from at least one user via a user interface of a user device. The input data may include at least one of claim data, claimant attributes, provider information, and one or more insurance policy documents. Further, the computer-implemented system may extract insurance-related data from the input data using a first Generative Artificial Intelligence (Gen AI) model. The extracted insurance-related data may include at least one of structured claim attributes and unstructured claim attributes. The extracted insurance-related data may include at least one of diagnosis codes, procedure codes, treatment descriptions, and contextual claim attributes. Furthermore, the computer-implemented system may generate, using a reasoning agent including a Gen AI model, a sequence of dynamically determined evaluation instructions for adjudicating the insurance claim. The sequence of dynamically determined evaluation instructions for adjudicating the insurance claim may be generated based on one or more contextually relevant policy sections and the extracted insurance-related data. Each of the dynamically determined evaluation instructions may correspond to a policy interpretation step obtained from the one or more contextually relevant policy sections of the one or more insurance policy documents. In addition, the computer-implemented system may identify the plurality of agentic Artificial Intelligence (AI) models for executing the sequence of the dynamically determined evaluation instructions. The plurality of agentic AI models may include at least of a data extraction agent, a policy evaluation agent, and the reasoning agent. Further, the computer-implemented system may execute the sequence of dynamically determined evaluation instructions by selectively applying the sequence of the dynamically determined evaluation instructions at the identified plurality of agentic AI models. Furthermore, the computer-implemented system may validate an output of the identified plurality of AI models based on execution of the sequence of the dynamically determined evaluation instructions at the identified plurality of agentic AI models. In addition, the computer-implemented system may determine one or more actions for claim adjudication using a stepwise reasoning path model and results of validation. The one or more actions may include retrieving additional claim data, generating external application programming interfaces (APIs), and refining a policy evaluation. Further, the computer-implemented system may generate a final claim result based on the stepwise reasoning path model and the determined one or more actions. Furthermore, the computer-implemented system may output the final claim result and an explanation data corresponding to the final result on the user interface of the user device. The explanation data may include at least one of references to the one or more insurance policy documents and the stepwise reasoning path model.

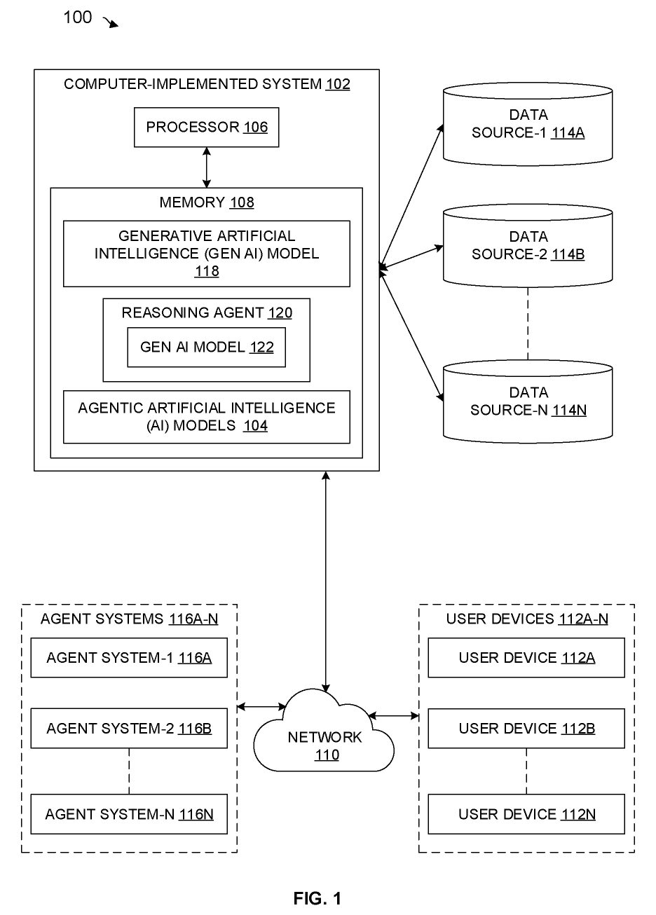

Referring now to the drawings, and more particularly to FIGS. 1 through 7 , where similar reference characters denote corresponding features consistently throughout the figures, there are shown preferred examples, and these examples are described in the context of the following exemplary system and/or method.

FIG. 1 illustrates an example block diagram representation of a network architecture 100 for a computer-implemented system 102 for determining outcomes of insurance claims using a plurality of agentic Artificial Intelligence (AI) models 104, according to an example. The network architecture 100 may include the computer-implemented system 102, a processor 106 (collectively referred to as one or more processors 106), a memory 108, a plurality of modules (not depicted in FIG. 1), a network 110, one or more user devices 112A-N (collectively referred to as the one or more user devices 112A-N, and individually referred to a user device-1 112A, a user device-2 112B through a user device-N 112N), one or more data sources 114A, 114B,…,114N (collectively referred to as the one or more data sources 114A-N and individually referred to as a data source-1 114A, a data source-2 114B through a data source-N 114N), and a plurality of agent systems 116A, 116B,…, 116N (collectively referred to as the plurality of agent systems 116A-N and individually referred to as an agent system-1 116A, an agent system-2 116B through an agent system-N 116N). The memory 108 may include a first Generative Artificial Intelligence (Gen AI) model 118, a reasoning agent 120 including a Gen AI model 122 and the plurality of agentic Artificial Intelligence (AI) models 104.

In an example, the computer-implemented system 102 may be communicatively connected to the plurality of agent systems 116A-N via the network 110. Further, the computer-implemented system 102 may be connected to the one or more user devices 112A-N (interchangeably referred to as the user device 112) via the network 110. Furthermore, the computer-implemented system 102 may be communicatively connected to the one or more data sources 114A-N.

In an example, the processor 106 may refer to one or more computational processing units. The one or more computational processing units may be configured to execute one or more processor-executable instructions stored in the memory 108 for processing the insurance claims using the plurality of agentic Artificial Intelligence (AI) models 104. The processor 106 may be configured to receive input data corresponding to an insurance claim from the user device 112 via a user interface. Further, the processor 106 may be configured to extract insurance-related data using the first Generative Artificial Intelligence (Gen AI) model 118. Furthermore, the processor 106 may be configured to generate a sequence of dynamically determined evaluation instructions using the reasoning agent 120. In addition, the processor 106 may be configured to identify the plurality of agentic AI models 104 for executing the sequence of dynamically determined evaluation instructions. Further, the processor 106 may be configured to validate outputs generated by the plurality of agentic AI models 104. Furthermore, the processor 106 may be configured to determine one or more actions for claim adjudication based on a stepwise reasoning path model. In addition, the processor 106 may be configured to generate a final claim result along with an explanation data. The processor 106 may include, such as, for example, but not limited to, one or more of a Central Processing Unit (CPU), a Graphics Processing Unit (GPU), a Tensor Processing Unit (TPU), one or more Application-Specific Integrated Circuits (ASICs), one or more Field-Programmable Gate Arrays (FPGAs), and/or one or more cloud-based computing resources.

In another example, the memory 108 may include one or more volatile storage elements and one or more non-volatile storage elements. The memory 108 may be configured to store at least one of one or more processor-executable instructions, one or more intermediate computational states, and one or more learned parameters associated with the first Generative Artificial Intelligence (Gen AI) model 118, the reasoning agent 120, and the plurality of agentic Artificial Intelligence (AI) models 104 executed by the computer-implemented system 102. The memory 108 may include, such as, for example, but not limited to, a Random Access Memory (RAM), a Read-Only Memory (ROM), one or more solid-state storage devices, and/or a distributed cloud-based storage. Further, the memory 108 may store the input data corresponding to the insurance claims, the extracted insurance-related data, at least one of structured claim attributes and unstructured claim attributes, one or more contextually relevant policy sections retrieved from one or more insurance policy documents, dynamically determined evaluation instructions, one or more intermediate evaluation results, validation outputs, a stepwise reasoning path model, and a final claim result along with the explanation data. The memory 108 may further store historical claim data, user feedback, and model performance data for validation and iterative refinement. The memory 108 may be implemented as a non-transitory computer-readable storage medium communicatively coupled to the processor 106 for executing the operations described herein.

In yet another example, the plurality of modules (not depicted in FIG. 1) may be implemented as one or more intercommunicating software sub-systems. The plurality of modules may be configured for processing the insurance claims using the plurality of agentic Artificial Intelligence (AI) models 104. The plurality of modules may perform a plurality of functions. The plurality of functions may include, such as, for example, but not limited to, receiving the input data corresponding to the insurance claim, extracting insurance-related data, one or more contextually relevant policy sections, generating the sequence of dynamically determined evaluation instructions, orchestrating execution across the plurality of agentic AI models 104, validating outputs, determining one or more actions for claim adjudication, and generating the final claim result with the explanation data. The plurality of modules may incorporate the first Generative Artificial Intelligence (Gen AI) model 118 and the reasoning agent 120 for contextual reasoning, policy interpretation, and iterative refinement of intermediate and final outputs. The plurality of modules may include a data receiving module (not depicted in FIG. 1), a data extraction module (not depicted in FIG. 1), a policy evaluation instruction generation module (not depicted in FIG. 1), an identification module (not depicted in FIG. 1), an instruction execution module (not depicted in FIG. 1), an output validation module (not depicted in FIG. 1), a determination module (not depicted in FIG. 1), a claim result generation module (not depicted in FIG. 1), an output module (not depicted in FIG. 1) and the like modules (not depicted in FIG. 1).

In another example, the network 110 may represent a communication layer within the network architecture 100 configured to provide secure and efficient data exchange between the computer-implemented system 102, the one or more user devices 112A-N, one or more external data sources, and one or more policy databases. The network 110 may provide a transmission of the input data corresponding to the insurance claim, the extracted insurance-related data, one or more contextually relevant policy sections, a sequence of dynamically determined evaluation instructions, one or more intermediate evaluation results, and the final claim result along with the explanation data. Further, the network 110 may provide at least one of a real-time bidirectional communication for one or more interactions and background data synchronization for retrieval of one or more corresponding insurance policy documents, a historical claim data, and a model-related data. In an example, the network 110 may utilize encrypted communication protocols for secure data transmission and may employ at least one of message-based and event-driven communication mechanisms to support scalable execution and continuous updates within the system. Further, the network 110 may include, such as, for example, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fibre optic network, a satellite network, a cloud computing network, a combination of networks, and the like. The wired communication network may include, such as, for example, but not limited to, one or more ethernet connections, one or more fiber optics, one or more Power Line Communications (PLCs), one or more serial communications, one or more coaxial cables, a quantum communication, an advanced fiber optics, one or more hybrid networks, and the like. The wireless communication network may include, such as, for example, but not limited to, a wireless fidelity (wi-fi), one or more cellular networks including, such as, for example, but not limited to, fourth generation (4G) technologies and fifth generation (5G) technologies), Bluetooth^{®}, ZigBee^{®}, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like

In another example, the user device 112 may include a computing device. The computing device may be configured to receive the input data corresponding to the insurance claim via the user interface and to output the final claim result along with corresponding explanation data. The user device 112 may include, such as, for example, but not limited to, a desktop computer, a laptop computer, a tablet device, a mobile device, and/or a workstation, a personal digital assistant (PDA), a tablet computer, a wearable computing device, a virtual reality/augmented reality (VR/AR) device, and the like. Further, the user device 112 may be configured to transmit the input data, including at least one of claim data, claimant attributes, provider information, and one or more insurance policy documents, to the computer-implemented system 102 over the network 110. The user device 112 may receive the final claim result and the explanation data. The explanation data may include at least one of references to the one or more insurance policy documents and a stepwise reasoning path model, and may present the received information via the user interface. Further, the user device 112 may be configured to receive user feedback, including approval, rejection, and/or modification inputs, and transmit the user feedback for further processing by the computer-implemented system 102. In another example, the user device 112 may be configured to enable one or more users to interact with the computer-implemented system 102. The one or more user devices 112A-N may be digital devices, computing devices, and/or networks. In another example, the computer-implemented system 102 may include the user interface associated with the user device 112. The user interface may be configured to output the final claim result and the explanation data corresponding to the final claim result. The user interface may further provide monitoring of adjudicated insurance claims. Further, the user interface display the stepwise reasoning path model and references to the one or more insurance policy documents. Furthermore, the user interface may provide a manual intervention by at least one user for claims flagged for review.

In another example, the user device 112 may be associated with, such as, for example, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In another example, the one or more data sources 114A-N may include one or more internal and/or external repositories configured to provide data for processing insurance claims. The one or more data sources 114A-N may include, such as, for example, but not limited to, one or more policy databases storing the one or more insurance policy documents, one or more claim management systems storing historical claim data, Electronic Health Record (EHR) systems, billing systems, and/or third-party data providers. Further, the one or more data sources 114A-N may provide the input data. The input data may include at least one of claim data, claimant attributes, provider information, and contextual data for generating the final claim result and the explanation data.

In another example, the plurality of agent systems 116A-N may include a set of agentic Artificial Intelligence (AI) models. The plurality of agent systems 116A-N may be configured to collaboratively execute a sequence of dynamically determined evaluation instructions. The plurality of agent systems 116A-N may include, such as, for example, but not limited to, a data extraction agent, a policy evaluation agent, and the reasoning agent 120. Each of the plurality of agent systems 116A-N may be configured to perform one or more specialized tasks. The one or more specialized tasks may include, such as, for example, but not limited to, extracting the insurance-related data, interpreting a plurality of policy clauses, and generating one or more intermediate evaluation results. Further, the plurality of agent systems 116A-N may communicate with each other to update one or more intermediate states and provide an execution of the stepwise reasoning path model.

In another example, the first Generative Artificial Intelligence (Gen AI) model 118 may be configured to extract the insurance-related data from the input data corresponding to the insurance claim. The first Gen AI model 118 may process structured and unstructured data. The structured and unstructured data may include, such as, for example, but not limited to, one or more free-text treatment descriptions, one or more provider notes, and one or more claim forms to generate the at least one of structured claim attributes and unstructured claim attributes. The at least one of structured claim attributes and unstructured claim attributes may include, such as, for example, but not limited to, one or more diagnosis codes, one or more procedure codes, one or more treatment descriptions, and the contextual claim attributes. Further, the first Gen AI model 118 may utilize, such as, for example, but not limited to, one or more transformer-based models. The one or more transformer-based models for tokenization, entity recognition, and mapping to standardized coding systems. In another example, the computer-implemented system 102 for determining the insurance claims using the plurality of agentic Artificial Intelligence (AI) models 104. The computer-implemented system 102 may be configured to automate an adjudication of the insurance claims by utilizing the one or more Generative Artificial Intelligence (Gen AI) models. The one or more Gen AI models may include, such as, for example, but not limited to, one or more Large Language Models (LLMs). The one or more LLMs may be used for interpreting the input data corresponding to the insurance claim. Further, the one or more LLMs may be used for applying one or more contextually relevant policy sections from one or more insurance policy documents. The computer-implemented system 102 may generate the final claim result and the explanation data with reduced human intervention by executing the sequence of dynamically determined evaluation instructions derived from the policy interpretation steps.

In another example, the reasoning agent 120 may include a Generative Artificial Intelligence (Gen AI) model. The Gen AI model 122 may be configured to generate the sequence of dynamically determined evaluation instructions for adjudicating the insurance claim. The reasoning agent 120 may retrieve contextually relevant policy sections from the one or more insurance policy documents, segment the policy sections into policy clauses, and determine policy interpretation steps using a stepwise chain of thought reasoning process. Further, the reasoning agent 120 may generate and update a stepwise reasoning path model. Furthermore, the reasoning agent 120 may generate the explanation data. The explanation data may include references to policy sections and reasoning steps. In another example, the computer-implemented system 102 may include the first Generative Artificial Intelligence (Gen AI) model 118 and the reasoning agent 120 including the Gen AI model 122. The first Gen AI model 118 may be configured to extract the insurance-related data from the input data, including at least one of the structured claim attributes and unstructured claim attributes. The reasoning agent 120 may be configured to generate a sequence of dynamically determined evaluation instructions using a stepwise chain-of-thought reasoning process based on the extracted insurance-related data and one or more contextually relevant policy sections. The reasoning agent 120 may further determine subsequent evaluation operations and generate corresponding evaluation instructions for adjudicating the insurance claim. Further, the computer-implemented system 102 may be configured to flag the insurance claims requiring further evaluation for manual review and output the final claim result via the user interface. The reasoning agent 120 may provide one or more stepwise chain-of-thought reasoning techniques to process multimodal data. The multimodal data may include at least one of textual data, image data, and structured data to determine subsequent evaluation instructions. The reasoning agent 120 may further log a stepwise reasoning path model representing the sequence of evaluation instructions and may delegate one or more evaluation steps to one or more Application Programming Interface (API)-based agentic AI models for further processing. The computer-implemented system 102 may validate a compliance of the insurance claim with coverage conditions, eligibility criteria, and exclusion rules defined in the one or more insurance policy documents. Further, the computer-implemented system 102 may be configured to adapt to updated policy guidelines by retraining and/or fine-tuning the one or more Gen AI models.

In another example, the first Gen AI model 118 may include one or more Generative Artificial Intelligence models configured to support at least one of policy interpretation, instruction generation, reasoning, validation, and explanation generation. The first Gen AI model 118 may include, such as, for example, but not limited to, one or more Large Language Models (LLMs) and/or one or more retrieval-augmented generation (RAG)-based models. The first Gen AI model 118 may be configured to process insurance policy documents, generate embeddings, retrieve relevant policy sections, and refine outputs based on intermediate evaluation results and user feedback.

In another example, the plurality of agentic Artificial Intelligence (AI) models 104 may refer to an autonomous or semi-autonomous computational model configured to execute one or more evaluation instructions within a coordinated multi-agent framework. The plurality of agentic AI models 104 may include, such as, for example, but not limited to, the data extraction agent, the policy evaluation agent, the reasoning agent 120, a counterfactual agentic AI model, a causal discrepancy agentic AI model, and/or a Bayesian anomaly agentic AI model. Further, each of the plurality of agentic AI models 104 may be configured to receive input parameters, generate evaluation results such as Boolean decisions, classifications, and/or numerical outputs, and update intermediate states for subsequent processing within the stepwise reasoning path model. In another example, the computer-implemented system 102 may include an instruction execution model. The instruction execution model may be configured to identify and apply the plurality of agentic Artificial Intelligence (AI) models 104, including at least one of the data extraction agent, the policy evaluation agent, and the reasoning agent 120, for executing the sequence of dynamically determined evaluation instructions. The plurality of agentic AI models 104 may be configured to evaluate claim compliance with policy guidelines, determine eligibility and coverage conditions, and generate one or more adjudication outcomes including at least one of an approval, a denial, and a pending status. Further, the reasoning agent 120 may maintain a stepwise reasoning path model and generate explanation data including references to the one or more insurance policy documents.

In an example, the computer-implemented system 102 for determining outcomes of insurance claims using the plurality of agentic Artificial Intelligence (AI) models 104 may be provided. The computer-implemented system 102 may include the processor 106 and the memory 108. The memory 108 may be communicably coupled to the processor 106. The memory 108 may include processor-executable instructions which, when executed by the processor 106, cause the processor 106 to receive input data corresponding to the insurance claim from at least one user via a user interface of the user device 112. The input data may include at least one of claim data, claimant attributes, provider information, and the one or more insurance policy documents. In an example, the input data may refer to data corresponding to the insurance claim received by the computer-implemented system 102 from at least one user via the user interface of the user device 112 and/or from the one or more data sources 114A-N. For example, the input data may include a claim submission. The claim submission may include, such as, for example, but not limited to, one or more diagnosis codes, one or more procedure codes, one or more billed amounts, one or more treatment descriptions, and one or more corresponding policy documents. The one or more corresponding policy documents may include, such as, for example, but not limited to, defining one or more coverage conditions and one or more exclusions. In another example, the computer-implemented system 102 may include one or more data receiving components. The one or more data receiving components may be configured to receive the input data corresponding to the insurance claim from at least one user and/or the one or more data sources 114A-N. The input data may include at least one of claim data, claimant attributes, provider information, and one or more insurance policy documents. Further, the computer-implemented system 102 may include at least one policy database configured to store the one or more insurance policy documents. The one or more insurance policy documents may include coverage conditions, exclusions, limitations, reimbursement rules, and medical necessity guidelines corresponding to one or more diagnosis codes, procedure codes, and contextual claim attributes. In an example, the computer-implemented system 102 may be communicatively coupled to the at least one policy database. The at least one policy database may be configured to store the one or more insurance policy documents in a structured format. The one or more insurance policy documents may include at least one of coverage conditions, exclusions, limitations, reimbursement rules, and medical necessity guidelines. The data extraction module and/or the reasoning agent 120 may be configured to retrieve the one or more contextually relevant policy sections from the at least one policy database based on the extracted insurance-related data to ensure application of applicable and up-to-date policy information.

In another example, the input data may be received in a standardized electronic format and/or from one or more third-party claims systems. The first Generative Artificial Intelligence (Gen AI) model 118 and/or the reasoning agent 120 may be configured to process the multimodal data including textual data, structured data, and image data using a multi-modal chain-of-thought reasoning technique. Further, the reasoning agent 120 may be configured to delegate one or more evaluation instructions to one or more application programming interface (API)-based agentic AI models and log reasoning outputs in a structured format for audit, validation, and evaluation purposes. Additionally, the extracted insurance-related data may include standardized coding systems such as diagnosis codes and procedure codes derived from one or more medical coding standards.

In another example, the insurance claim may refer to a request submitted for at least one of a reimbursement and/or a coverage of one or more services under the one or more insurance policy documents. The insurance claim may include information corresponding to the one or more services rendered to a claimant. Further, the insurance claims may form part of the input data processed by the computer-implemented system 102. For example, the insurance claim may include a submission for a reimbursement of a surgical procedure. The surgical procedure may include, such as, for example, but not limited to, one or more diagnosis codes, one or more procedure codes, one or more billed amounts, and one or more treatment descriptions, and/or a hospitalization claim. The hospitalization claim may include, such as, for example, but not limited to, one or more admission details, one or more discharge summaries, and one or more associated medical expenses.

In another example, the at least one user may refer to an individual and/or an entity interacting with the computer-implemented system 102 via the user interface of the user device 112 to submit input data corresponding to an insurance claim and/or receive a final claim result and corresponding explanation data. The at least one user may include, such as, for example, but not limited to, a claimant, a healthcare provider, an insurance agent, a claims processor, and/or a reviewer associated with an insurance organization.

The processor 106 may be configured to extract insurance-related data from the input data using the first Generative Artificial Intelligence (Gen AI) model 118. The extracted insurance-related data may include at least one of the structured claim attributes and the unstructured claim attributes. The extracted insurance-related data may include at least one of diagnosis codes, procedure codes, treatment descriptions, and contextual claim attributes. In an example, the insurance-related data may refer to data extracted from the input data corresponding to the insurance claim for further evaluation and adjudication. The insurance-related data may include the at least one of structured claim attributes and the unstructured claim attributes. Further, the insurance-related data may include, such as, for example, but not limited to, one or more diagnosis codes, one or more procedure codes, one or more treatment descriptions, and the contextual claim attributes. For example, the insurance-related data may include a mapped diagnosis code for a medical condition, a procedure code for a performed treatment, and a narrative description of the treatment extracted from clinical notes. In another example, the first Generative Artificial Intelligence (Gen AI) model 118 may refer to a model, which may be configured to process the input data and extract the insurance-related data. The first Gen AI model 118 may include, such as, for example, one or more transformer-based Large Language Models (LLMs). The one or more transformer-based Large Language Models (LLMs) may be configured for tokenization, entity recognition, and mapping of textual data to structured formats. For example, the first Gen AI model 118 may process a free-text medical report to identify diagnosis codes and procedure codes and convert the identified information into the structured claim attributes.

In another example, the structured claim attributes may refer to predefined and formatted data fields. The unstructured claim attributes may refer to free-text data and/or non-standardized data extracted from the input data. The structured claim attributes may include, such as, for example, but not limited to, one or more coded fields. The one or more coded fields may include, such as, for example, but not limited to, one or more diagnosis codes, one or more procedure codes, one or more billed amounts, and one or more service dates. The unstructured claim attributes may include, such as, for example, but not limited to, one or more narrative treatment descriptions, one or more clinical notes, an inferred severity, and a contextual claim information derived from a textual content.

In another example, the diagnosis codes may refer to one or more standardized codes representing a plurality of medical conditions. The procedure codes may refer to the one or more standardized codes representing one or more medical procedures performed. The treatment descriptions may refer to textual descriptions of medical services and/or procedures, and the contextual claim attributes may refer to inferred or derived information associated with the claim, such as severity of condition, place of service, and/or treatment context. For example, the diagnosis codes may indicate a cardiac condition. The procedure codes may indicate a surgical intervention. The treatment descriptions may include a narrative of the performed surgery. The contextual claim attributes may indicate, which the procedure may be performed in an emergency setting.

Further, the processor 106 may be configured to generate, using the reasoning agent 120 including the Gen AI model 122, a sequence of dynamically determined evaluation instructions for adjudicating the insurance claim, based on one or more contextually relevant policy sections and the extracted insurance-related data. Each of the dynamically determined evaluation instructions may correspond to a policy interpretation step obtained from the one or more contextually relevant policy sections of the one or more insurance policy documents. In an example, the reasoning agent 120 may refer to a Generative Artificial Intelligence (Gen AI) based agent. The reasoning agent 120 may be configured to generate a sequence of dynamically determined evaluation instructions for adjudicating the insurance claim based on the extracted insurance-related data and the one or more contextually relevant policy sections. The reasoning agent 120 may perform a stepwise reasoning to derive one or more policy interpretation steps and construct the stepwise reasoning path model. For example, the reasoning agent 120 may analyze a claim. The claim may include, such as, for example, but not limited to, a procedure code and a diagnosis code. Further, the claim may include retrieve relevant policy clauses related to coverage conditions. Furthermore, the claim may include generate evaluation instructions to determine whether the procedure satisfies one or more medical necessity requirements under the policy.

In another example, the Gen AI model 122 may refer to one or more Generative Artificial Intelligence models utilized by the reasoning agent 120 and one or more modules for performing at least one of a policy interpretation, an instruction generation, a reasoning generation, and an explanation generation. The Gen AI model 122 may include, such as, for example, but not limited to, one or more transformer-based Large Language Models (LLMs), one or more Retrieval-Augmented Generation (RAG)-based models, and/or one or more domain-adapted language models trained on at least one of an insurance data and a healthcare data. For example, the Gen AI model 122 may include may refer to one or more Generative Artificial Intelligence (AI) models. The one or more Generative AI models may be utilized by the reasoning agent 120 and the one or more modules for performing policy interpretation, instruction generation, reasoning, and explanation generation. The Gen AI model 122 may include, such as, for example, but not limited to, one or more transformer-based Large Language Models (LLMs), one or more retrieval-augmented generation (RAG)-based models, and/or one or more domain-adapted language models trained on the insurance data and the healthcare data. For example, the Gen AI model 122 may include, such as, for example, but not limited to, a transformer-based LLM, a retrieval-augmented generation (RAG) model, and a fine-tuned domain-specific language model. The transformer-based LLM may be configured to interpret insurance policy documents and generate policy interpretation steps. The RAG model may be configured to retrieve contextually relevant policy sections from the one or more insurance policy documents and incorporate the retrieved information into reasoning. The fine-tuned domain-specific language model may be configured to generate explanation data corresponding to the final claim result based on the stepwise reasoning path model. In another example, the Gen AI model 122 may be configured to process a policy clause related to coverage limits. The Gen AI model 122 may be configured to generate an evaluation instruction to compare billed amounts against allowable limits. Further, the Gen AI model 122 may be configured to generate explanation data indicating the policy basis for approval and/or denial of the insurance claim.

In another example, the sequence of dynamically determined evaluation instructions may refer to an ordered set of instructions generated by the reasoning agent 120 for adjudicating an insurance claim based on the extracted insurance-related data and one or more contextually relevant policy sections. Each evaluation instruction may correspond to a policy interpretation step and may include at least one of a policy clause identifier, required input parameters, and expected output parameters. The sequence may be dynamically determined based on claim-specific attributes and retrieved policy conditions and may be iteratively updated during execution. For example, the sequence of dynamically determined evaluation instructions may include, such as, for example, but not limited to, verifying eligibility of a procedure based on a diagnosis code. The sequence of dynamically determined evaluation instructions may include checking coverage conditions under a relevant policy clause. Further, the sequence of dynamically determined evaluation instructions may include evaluating medical necessity requirements. Furthermore, the sequence of dynamically determined evaluation instructions may include calculating payable amounts based on coverage limits and deductibles. In another example, for a hospitalization claim, the sequence may include validating admission criteria. The sequence may further include verifying duration of stay against policy limits. Further, the sequence may include determining reimbursement based on predefined policy rules.

In another example, the one or more contextually relevant policy sections may refer to one or more portions of the one or more insurance policy documents. The one or more contextually relevant policy sections may be identified as applicable to an insurance claim based on the extracted insurance-related data. The one or more contextually relevant policy sections may include, such as, for example, but not limited to, one or more coverage conditions, exclusions, limitations, reimbursement rules, and medical necessity guidelines corresponding to diagnosis codes, procedure codes, and contextual claim attributes. For example, for a claim including a surgical procedure, the one or more contextually relevant policy sections may include a coverage clause specifying eligibility criteria for the procedure. The one or more contextually relevant policy sections may include an exclusion clause related to pre-existing conditions, and a reimbursement rule defining allowable limits. In another example, for a hospitalization claim, the one or more contextually relevant policy sections may include one or more policy clauses related to at least one of an admission criteria, a duration of stay limits, and a covered room charge.

In another examples, the policy interpretation step may refer to an operation derived from the one or more contextually relevant policy sections for evaluating the insurance claim. The policy interpretation step may represent an application of a policy clause to the extracted insurance-related data to determine at least one of eligibility, coverage, limitation, and/or reimbursement. Further, the policy interpretation step may be represented as an evaluation instruction within the sequence of dynamically determined evaluation instructions. For example, the policy interpretation step may include verifying whether a procedure code may be covered under a specific policy clause. The policy interpretation step may include determining whether a diagnosis may satisfy a medical necessity requirement. Further, the policy interpretation step may include applying an exclusion for a pre-existing condition. Furthermore, the policy interpretation step may include calculating a payable amount based on coverage limits and deductibles. In another example, the policy interpretation step may include comparing a duration of hospitalization with a maximum allowable stay defined in the insurance policy document.

Furthermore, the processor 106 may be configured to identify the plurality of agentic Artificial Intelligence (AI) models 104 for executing the sequence of the dynamically determined evaluation instructions. The plurality of agentic AI models 104 may include at least of the data extraction agent, the policy evaluation agent, and the reasoning agent 120. In an example, the plurality of agentic Artificial Intelligence (AI) models 104 may refer to a set of Artificial Intelligence (AI) models. The plurality of agentic AI models 104 may be configured to collaboratively execute the sequence of dynamically determined evaluation instructions for adjudicating the insurance claim. Further, each of the plurality of agentic AI models 104 may perform a specialized function within a coordinated framework. The plurality of agentic AI models 104 may include, such as, for example, but not limited to, the data extraction agent. The data extraction agent may be configured to extract insurance-related data. Further, the policy evaluation agent may be configured to interpret the one or more contextually relevant policy sections. Furthermore, the reasoning agent 120 may be configured to generate and update the stepwise reasoning path model. Further, the plurality of agentic AI models 104 may include one or more Generative Artificial Intelligence (Gen AI) models. The one or more Gen AI models may include, such as, for example, but not limited to, one or more transformer-based models. The one or more transformer-based models may include, such as, for example, but not limited to, a Text to Text Transfer Transformer (T5) model, a Generative Pre-trained Transformer (GPT) model, and a Bidirectional Encoder Representations from Transformers (BERT) based model for a natural language understanding and a policy interpretation, one or more Retrieval Augmented Generation (RAG) based models for retrieving the one or more contextually relevant policy sections. Further, the one or more transformer-based models may include, such as, for example, but not limited to, one or more named entity recognition models for extracting diagnosis codes and procedure codes, one or more classification models for determining claim disposition, one or more graph-based models. The one or more graph-based models may include, such as, for example, but not limited to, one or more Graph Neural Networks (GNNs) models for generating the trust graph, one or more probabilistic models and one or more causal inference models. The one or more probabilistic models may include, such as, for example, but not limited to, one or more Bayesian models for computing one or more anomaly scores. The one or more causal inference models may be used for evaluating causal consistency. The plurality of agentic AI models 104 may operate in coordination to generate the final claim result and the explanation data.

In another example, the computer-implemented system 102 may be configured to perform operations. The operations may include, such as, for example, but not limited to, an insurance claim, extracting insurance-related data using the first Gen AI model 118, retrieving one or more contextually relevant policy sections, generating a sequence of dynamically determined evaluation instructions using the reasoning agent 120, executing the sequence using the plurality of agentic AI models 104, and generating a final claim result along with explanation data. The explanation data may include a rationale for the final claim result with references to the one or more insurance policy documents and the stepwise reasoning path model.

In another example, the data extraction agent may refer to an agentic Artificial Intelligence (AI) model. The data extraction agent may be configured to extract the insurance-related data from the input data corresponding to the insurance claim, including at least one of the structured claim attributes and the unstructured claim attributes. The insurance claims may include, such as, for example, but not limited to, a plurality of diagnosis codes, a plurality of procedure codes, and a plurality of treatment descriptions. The policy evaluation agent may refer to an agentic AI model. Further, the policy evaluation agent may be configured to interpret the one or more contextually relevant policy sections from the one or more insurance policy documents and apply policy rules to the extracted insurance-related data to determine one or more coverage conditions, one or more exclusions, and a reimbursement criteria. The reasoning agent 120 may refer to a Generative Artificial Intelligence (Gen AI)-based agent. Further, the reasoning agent 120 may be configured to generate the sequence of dynamically determined evaluation instructions and the stepwise reasoning path model for adjudicating the insurance claim. For example, the data extraction agent may process a medical claim form to identify diagnosis and procedure codes. Further, the policy evaluation agent may determine whether the identified procedure is covered under a policy clause. Furthermore, the reasoning agent 120 may generate evaluation instructions to verify medical necessity and calculate payable amounts based on the policy conditions.

In addition, the processor 106 may be configured to execute the sequence of dynamically determined evaluation instructions by selectively applying the sequence of the dynamically determined evaluation instructions at the identified plurality of agentic AI models. In an example, the identified plurality of agentic AI models In an example, the identified plurality of agentic Artificial Intelligence (AI) models may refer to a subset of the plurality of agentic AI models 104 selected for executing the sequence of dynamically determined evaluation instructions based on one or more required operation types and input parameters associated with each evaluation instruction. The identified plurality of agentic AI models may be selected by the processor 106 using metadata corresponding to capabilities of each of the plurality of agentic AI models 104. The plurality of agentic AI models 104 may include, such as, for example, but not limited to, one or more input types, one or more output types, and one or more policy evaluation functions. The identified plurality of agentic AI models may include, such as, for example, at least one of the data extraction agent, the policy evaluation agent, and the reasoning agent 120. For example, for an evaluation instruction requiring extraction of diagnosis codes from unstructured text, the identified plurality of agentic AI models may include the data extraction agent. Further, for an evaluation instruction corresponding to application of a policy clause, the identified plurality of agentic AI models may include the policy evaluation agent. Furthermore, for an evaluation instruction requiring a generation of subsequent evaluation steps and/or the explanation data, the identified plurality of agentic AI models may include the reasoning agent 120.

Further, the processor 106 may be configured to validate an output of the identified plurality of AI models based on execution of the sequence of the dynamically determined evaluation instructions at the identified plurality of agentic AI models. In an example, the output of the identified plurality of Artificial Intelligence (AI) models may refer to one or more evaluation results. The one or more evaluation results may be generated upon an execution of the sequence of dynamically determined evaluation instructions by the identified plurality of agentic AI models. The output may include, such as, for example, but not limited to, one or more Boolean decisions, one or more numerical values, one or more classification labels, one or more extracted data fields, and one or more intermediate reasoning results associated with one or more policy interpretation steps. The output may further be aggregated, validated, and utilized for generating the stepwise reasoning path model and determining one or more actions for claim adjudication. For example, the output may include a Boolean decision. The Boolean decision may indicate whether a procedure may be covered under a policy clause, a numerical value representing a payable amount, a classification label indicating approval, a denial status, and/or a pending status, and the extracted data. The output may include, such as, for example, but not limited to, a plurality of normalized diagnosis codes and/or a plurality of treatment details generated by the data extraction agent, the policy evaluation agent, and the reasoning agent 120.

Furthermore, the processor 106 may be configured to determine one or more actions for claim adjudication using a stepwise reasoning path model and results of validation. The one or more actions may include retrieving additional claim data, generating external application programming interfaces (APIs), and refining a policy evaluation. In an example, the one or more actions may refer to one or more operations determined by the processor 106 based on the stepwise reasoning path model and the results of validation for adjudicating the insurance claim. The one or more actions may include, such as, for example, but not limited to, retrieving an additional claim data from the one or more data sources 114A-N. Further, the one or more actions may include, such as, for example, but not limited to, generating or invoking one or more external application programming interfaces (APIs). Furthermore, the one or more actions may include, such as, for example, but not limited to, refining a policy evaluation by updating and/or regenerating one or more evaluation instructions. The one or more actions may be iteratively executed until a completion of evaluation of the insurance claim. For example, the one or more actions may include retrieving missing clinical documents for verifying medical necessity, invoking an external Application Programming Interface (API) to obtain provider eligibility information, and refining a policy evaluation by re-evaluating a coverage condition based on updated claim attributes. In an example, the computer-implemented system 102 may utilize one or more external APIs and database lookups to retrieve additional policy data, validate insurance-related data, and determine one or more actions. The reasoning agent 120 including the Gen AI model 122 may apply the one or more stepwise chain-of-thought reasoning techniques. Further, the reasoning agent 120 may analyze the insurance claim based on the one or more insurance policy documents, one or more Standard Operating Procedure (SOPs), and the extracted insurance-related data. The reasoning agent 120 may dynamically refine the sequence of dynamically determined evaluation instructions and generate the final claim result. The computer-implemented system 102 may log the evaluation instructions, intermediate results, and the final claim result to provide traceability and compliance with the one or more insurance policy documents, the regulatory requirements, and the audit standards.

In another example, the stepwise reasoning path model may refer to a structured representation of the sequence of dynamically determined evaluation instructions. Further, one or more nodes may correspond to one or more policy interpretation steps and one or more edges may represent one or more dependencies between the evaluation results. The results of validation may refer to one or more outputs generated by validating the evaluation results from the identified plurality of agentic AI models. The identified plurality of agentic AI models may include, such as, for example, but not limited to, one or more validated results, one or more flagged results, and one or more associated confidence scores. The stepwise reasoning path model and the results of validation may be utilized to determine the one or more actions for adjudicating an insurance claim. For example, the stepwise reasoning path model may represent a sequence including, such as, but not limited to, a verification of coverage eligibility, an evaluation of a medical necessity, and a calculation of a payable amount. The results of validation may indicate that a coverage condition may be satisfied. Further, the results of validation may indicate a medical necessity check may be flagged for an additional review. Furthermore, the results of validation may indicate a confidence score may be assigned to each evaluation result based on consistency checks.

In another example, the additional claim data may refer to supplementary data associated with the insurance claim. The additional claim data may be retrieved to complete adjudication, including, such as, for example, but not limited to, a missing clinical record, a prior claim history, a laboratory report, and/or a provider documentation. The external application programming interfaces (APIs) may refer to one or more interfaces. Further, the external APIs may be configured to provide communication with one or more external systems for obtaining a relevant information. The relevant information may include, such as, for example, but not limited to, one or more provider eligibility verification systems, one or more medical coding databases, one or more fraud detection systems, and/or one or more third-party data services. The policy evaluation may refer to an application of the one or more contextually relevant policy sections to the extracted insurance-related data to determine one or more coverage conditions, one or more exclusions, one or more limitations, and one or more reimbursement outcomes. For example, the additional claim data may include, such as, for example, but not limited to, retrieving a discharge summary to verify treatment details, the external APIs may be invoked to obtain at least one of one or more updated provider credentials and/or a standardized coding information, and the policy evaluation may include re-assessing whether a procedure may satisfy a medical necessity criteria based on one or more updated claim attributes.

In addition, the processor 106 may be configured to generate a final claim result based on the stepwise reasoning path model and the determined one or more actions. In an example, the final claim result may refer to an outcome. The final claim result may be generated by the computer-implemented system 102 for the insurance claim based on the stepwise reasoning path model and determined one or more actions. The final claim result may include at least one of an approval, a denial, and/or a pending status. Further, the final claim result may include a calculated payable amount based on at least one of one or more coverage conditions, one or more deductibles, one or more copayments, and one or more policy limits. For example, the final claim result may indicate approval of a surgical procedure with a payable amount after applying deductible and coinsurance, denial of a claim based on a policy exclusion, and/or a pending status requiring an additional documentation.

In an example, the determined one or more actions may refer to actions identified by the processor 106 based on the stepwise reasoning path model and the results of validation to complete adjudication of the insurance claim. The determined one or more actions may include, such as, for example, but not limited to, retrieving the additional claim data, invoking the external application programming interfaces (APIs), and refining the policy evaluation by updating and/or regenerating one or more evaluation instructions. Further, the determined one or more actions may include, such as, for example, but not limited to, retrieving one or more missing medical records to verify one or more treatment details, invoking the external APIs to validate provider eligibility, and refining a policy evaluation by re-evaluating a coverage condition based on the updated claim information.

Further, the processor 106 may be configured to output the final claim result and an explanation data corresponding to the final result on the user interface of the user device 112. The explanation data may include at least one of references to the one or more insurance policy documents and the stepwise reasoning path model. In an example, In an example, the explanation data may refer to information generated by the computer-implemented system 102 to provide a rationale corresponding to the final claim result. The explanation data may include at least one of the references to the one or more insurance policy documents and the stepwise reasoning path model representing policy interpretation steps leading to the final claim result. For example, the explanation data may include a sequence of reasoning steps. The sequence of reasoning steps may indicate that a procedure may be covered under a specific policy clause. Further, the sequence of reasoning steps may indicate that a claim may be denied based on an exclusion condition derived from the one or more insurance policy documents. Furthermore, the computer-implemented system 102 may be configured to output the final claim result to the at least one user including at least one of a healthcare provider and a payer. The user interface may provide monitoring of adjudicated insurance claims. Further, the user interface may provide manual review of flagged claims. Furthermore, the user interface may present the explanation data including detailed reasoning and references to the one or more insurance policy documents. In another example, the references may refer to at least one of one or more identifiers, one or more pointers, and/or one or more links associated with specific portions of the one or more insurance policy documents. Further, the references may be utilized during claim adjudication. The references may include, such as, for example, but not limited to, one or more policy clause identifiers, one or more section numbers, one or more paragraph excerpts, one or more coverage conditions, one or more exclusion clauses, and one or more reimbursement rules corresponding to the final claim result. For example, a reference may include a section number of a policy document defining a coverage eligibility for a procedure. Further, the reference may include an identifier corresponding to an exclusion clause applied to deny the insurance claim.

In another example, for a healthcare insurance claim corresponding to a knee replacement procedure, the computer-implemented system 102 may extract the insurance-related data. Further, the computer-implemented system 102 may retrieve the one or more contextually relevant policy sections associated with the procedure. Furthermore, the computer-implemented system 102 may evaluate compliance with the one or more coverage conditions and medical necessity requirements. The computer-implemented system 102 may generate the final claim result. The final claim result may include at least one of approval, denial, and/or pending status, along with the explanation data including references to the one or more insurance policy documents. In another example, in a financial services application, the computer-implemented system 102 may process a request corresponding to at least one of a loan approval, a credit card application, and/or an appeal. Further, the request may be processed by validating input data against the one or more policy documents. The computer-implemented system 102 may be configured to determine eligibility and outcome using the plurality of agentic AI models 104. In another exemplary embodiment, the computer-implemented system 102 may be applicable to a plurality of domains. The plurality of domains may include, such as, for example, but not limited to, one or more types of the insurance claims. The one or more types of the insurance claims may include, such as, for example, but not limited to, a health insurance claim, an automobile insurance claim, a property and casualty insurance claim, a life insurance claim, a travel insurance claim, a liability insurance claim and the like.

In another example, the computer-implemented system 102 may implement claim adjudication using a combination of rule-based processing, decision trees, database lookups, one or more external application programming interfaces (APIs), and one or more Gen AI models. The computer-implemented system 102 may receive the claim data from an external claims management system. The external claims management system may include, such as, for example, but not limited to, a healthcare claims adjudication system. Further, the external claims management system may communicate through a message streaming platform. The claim data may be processed across one or more message topics. Furthermore, the computer-implemented system 102 may extract one or more edit codes from the claim data indicating required adjustments. The extracted information, along with decision logic stored in a database including a Resource Description Framework (RDF) store, may be processed using a Standard Operating Procedure (SOP) loader to determine applicable Standard Operating Procedures (SOPs). Further, a claims SOP processor may execute hierarchical evaluation instructions forming the sequence of dynamically determined evaluation instructions for adjudicating the insurance claim.

While the processors, components, elements, systems, subsystems, and/or computing devices described herein may be illustrated as single blocks, it may be appreciated by a person skilled in the art that such components may represent a plurality of interconnected elements communicatively coupled via the network 110. Further, data flows and control flows among the components illustrated in FIGS. 1-7 may correspond to processing operations for generating a final claim result and corresponding explanation data for an insurance claim using the plurality of agentic Artificial Intelligence (AI) models 104. Although FIGS. 1-7 depict structural and/or architectural relationships, the direction of data exchange, invocation of the plurality of agentic AI models 104, and control sequencing may follow a logical execution order defined by the sequence of dynamically determined evaluation instructions and associated method steps. Accordingly, the illustrated connections may be provided for explanatory purposes and may not limit sequence, concurrency, and/or dependency of operations performed by the computer-implemented system 102.

The computer-implemented system 102 may further include one or more middleware components (not shown in FIGS. 1-7). The one or more middleware components may be configured to provide at least one of a software-level support and a platform-level support for at least one of communication and interoperability among the one or more data sources 114A-N, one or more policy databases, the user device 112, and the processor 106 executing the plurality of modules. The one or more middleware components may manage at least one of a message routing, a data transformation, an authentication, an authorization, and a service orchestration across the network 110. Further, the one or more middleware components may be configured to provide a secure and an efficient exchange of the input data corresponding to the insurance claim, the extracted insurance-related data, the one or more contextually relevant policy sections, intermediate evaluation results, and the final claim result along with the explanation data. In some examples, the one or more middleware components may be optional and dependent on a deployment configuration of the computer-implemented system 102. Further, at least one of one or more additional servers, one or more middleware platforms, and/or one or more network services (not depicted in FIGS. 1-7) may be deployed to provide at least one of a monitoring operation, a logging operation, an auditing operation, a diagnostics operation, and a control operation associated with processing the insurance claim using the plurality of agentic AI models 104.

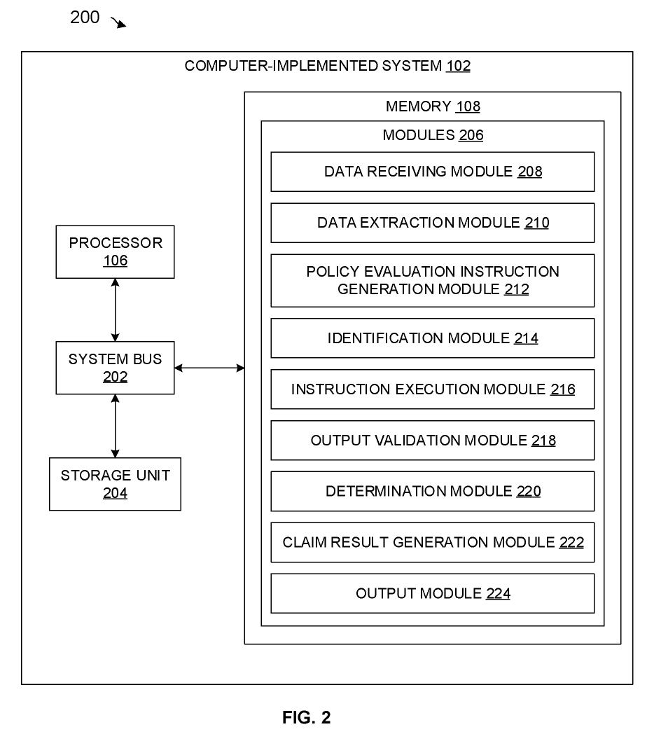

FIG. 2 illustrates an exemplary block diagram representation of an operational configuration 200 of the computer-implemented system 102 as shown in FIG. 1 for determining the outcomes of the insurance claims, according to an example.

In an example, the computer-implemented system 102 may include, such as, for example, but not limited to, a system bus 202, a storage unit 204, and the plurality of modules 206. The system bus 202 may function as a central conduit for at least one of a data transfer and a communication between the one or more processors 106, the memory 108, and the storage unit 204. The system bus 202 may provide an efficient exchange of information and instructions. Further, the system bus 202 may provide the coordinated operation of the computer-implemented system 102. The system bus 202 may be implemented using one or more technologies. The one or more technologies may include, such as, for example, but not limited to, one or more parallel buses, one or more serial buses, and one or more high-speed data transfer interfaces. The one or more high-speed data transfer interfaces may include, such as, for example, but not limited to, a universal serial bus (USB), a peripheral component interconnect express (PCIe), and one or more like standards. The storage unit 204 may be a cloud storage and/or the one or more data sources 114A-N such as those shown in FIG. 1. The storage unit 204 may store, such as, for example, but not limited to, the sequence of dynamically determined evaluation instructions, which may be generated by the computer-implemented system 102. The sequence of dynamically determined evaluation instructions may include, such as, for example, but not limited to, data receiving, data extracting, data mapping, decision generation, and the like. Additionally, the storage unit 204 may retain a previous sequence of the dynamically determined evaluation instructions for a comparison and a future reference. Further, the storage unit 204 may be configured to provide a continuous refinement of the computer-implemented system 102 over time. The storage unit 204 may be any kind of database such as, for example, but not limited to, one or more relational databases, dedicated databases, one or more dynamic databases, one or more monetized databases, one or more scalable databases, one or more cloud databases, one or more distributed databases, the like other databases, and a combination thereof.

The plurality of modules 206 may include the data receiving module 208, the data extraction module 210, the policy evaluation instruction generation module 212, the identification module 214, the instruction execution module 216, the output validation module 218, the determination module 220, the claim result generation module 222, the output module 224 and the like modules (not depicted in FIG. 2).

In an example, the data receiving module 208 may be configured to receive the input data corresponding to the insurance claim from the at least one user via the user interface of the user device 112. The data receiving module 208 may be configured to receive the input data corresponding to an insurance claim from at least one user via a user interface of one or more communication devices. The input data may be received from the one or more data sources 114A-N. Further, the input data may include the insurance claims and associated information. Furthermore, the data receiving module 208 may be configured to receive the input data corresponding to the insurance claim from at least one user via the user interface of the one or more user devices 112A-N. The input data may be received in one or more standardized formats. The one or more standardized formats may include, such as, for example, but not limited to, an Electronic Data Interchange (EDI), an eXtensible Markup Language (XML), and the like, to provide an interoperability across systems. The data receiving module 208 may further integrate with one or more external data sources including at least one of third-party claims systems, healthcare provider systems, and patient portals to capture insurance claims and associated information. The input data may include at least one of claim data, claimant attributes, provider information, and treatment-related information. The treatment-related information may include, such as, for example, but not limited to, the plurality of diagnosis codes, the plurality of procedure codes, and a plurality of medical services rendered by the user.

The data extraction module 210 may be configured to extract the insurance-related data from the input data using the first Generative Artificial Intelligence (Gen AI) model 118. The data extraction module 210 including the one or more Generative Artificial Intelligence (Gen AI) models. The one or more Gen AI models may include, such as, for example, but not limited to, one or more Large Language Models (LLMs). Further, the data extraction module 210 may be configured to extract the insurance-related data from the input data. Furthermore, the data extraction module 210 may be configured to retrieve one or more contextually relevant policy sections from at least one policy database associated with the one or more insurance policy documents. Further, the data extraction module 210 may be configured with the first Generative Artificial Intelligence (Gen AI) model 118 including the one or more Large Language Models (LLMs) and one or more Natural Language Processing (NLP) models. Further, the one or more NLP models may be configured to extract the insurance-related data from the input data. The data extraction module 210 may process textual and structured claim data to identify and categorize entities including at least one of diagnoses, procedures, medications, dates, and provider information. The one or more Gen AI models may include, such as, for example, but not limited to, one or more transformer-based models. The one or more transformer-based models may include, such as, for example, but not limited to, one or more Bidirectional Encoder Representations from Transformers (BERT)-based model, Generative Pre-trained Transformer (GPT)-based model, and the like. The data extraction module 210 may further standardize the extracted insurance-related data into a predefined format, including, such as, for example, but not limited to, mapping to standardized diagnosis codes and the plurality of procedure codes, to provide an efficient downstream processing.

The policy evaluation instruction generation module 212 may be configured to generate, using the reasoning agent 120 including the Gen AI model 122, a sequence of dynamically determined evaluation instructions for adjudicating the insurance claim, based on one or more contextually relevant policy sections and the extracted insurance-related data. In an example, the policy evaluation instruction generation module 212 may be configured to map the extracted insurance-related data to the one or more contextually relevant policy sections to provide policy interpretation in accordance with the one or more insurance policy documents. The reasoning agent 120 may further be configured with the one or more Gen AI models to generate a final claim result based on the extracted insurance-related data and the one or more contextually relevant policy sections. the policy evaluation instruction generation module 212 to map the extracted insurance-related data to the one or more contextually relevant policy sections. The policy evaluation instruction generation module 212 may provide the policy interpretation by aligning the claim attributes with corresponding policy clauses to evaluate at least one of claim validity, compliance, eligibility, and coverage conditions.

The identification module 214 may be configured to identify the plurality of agentic Artificial Intelligence (AI) models 104 for executing the sequence of the dynamically determined evaluation instructions. The instruction execution module 216 may be configured to execute the sequence of dynamically determined evaluation instructions by selectively applying the sequence of the dynamically determined evaluation instructions at the identified plurality of agentic AI models.

The output validation module 218 may be configured to validate the output of the identified plurality of AI models based on execution of the sequence of the dynamically determined evaluation instructions at the identified plurality of agentic AI models. The determination module 220 may be configured to determine the one or more actions for claim adjudication using the stepwise reasoning path model and results of validation. The claim result generation module 222 may be configured to generate the final claim result based on the stepwise reasoning path model and the determined one or more actions. In an example, the claim result generation module 222 may be configured to apply the one or more stepwise chain-of-thought reasoning techniques using the reasoning agent 120 to process multimodal data. The multimodal data may include, such as, for example, but not limited to, the at least one of textual data, image data, and structured data to determine the final claim result in accordance with policy guidelines. Further, the claim result generation module 222 may be configured to adapt to updated policy guidelines and conditions by retraining and/or fine-tuning the one or more Gen AI models. Additionally, the claim result generation module 222 may be applicable to adjudication across multiple domains including health insurance, other insurance types, and financial service applications. Further, the claim result generation module 222 may include the reasoning agent 120 configured with the Gen AI model 122 to generate a final claim result based on the extracted insurance-related data and the one or more contextually relevant policy sections. The reasoning agent 120 may generate and execute the sequence of dynamically determined evaluation instructions corresponding to policy interpretation steps. The final claim result may include at least one of an approval, a denial, and a pending status. The reasoning agent 120 may further generate the explanation data including rationale for the final claim result with references to the one or more insurance policy documents and corresponding policy sections. The output module 224 may be configured to output the final claim result and the explanation data corresponding to the final result on the user interface of the user device 112.

In another example, the processor 106 may be configured to generate a plurality of counterfactual scenarios, upon generating the sequence of dynamically determined evaluation instructions. Further, the plurality of counterfactual scenarios may be generated by perturbing at least one of the claim attributes within the structured claim attributes, the extracted insurance-related data, parameters of the one or more insurance policy documents and alternative interpretations of the unstructured claim attributes. In an example, the plurality of counterfactual scenarios may refer to a set of alternative variations of the insurance claim generated by modifying at least one of the claim attributes, the extracted insurance-related data, parameters of the one or more insurance policy documents, and/or interpretations of unstructured claim attributes to evaluate reliability of the final claim result. Each of the plurality of counterfactual scenarios may represent a hypothetical version of the insurance claim processed using the sequence of dynamically determined evaluation instructions to generate a corresponding counterfactual stepwise reasoning path. For example, the plurality of counterfactual scenarios may include modifying a diagnosis code to a related condition, and adjusting a billed amount. The plurality of counterfactual scenarios may further include altering a treatment description, and/or applying a different interpretation of a policy clause, and evaluating whether such modification changes the claim disposition from an approval to denial and/or vice versa.

The processor 106 may be configured to execute the sequence of dynamically determined evaluation instructions on each of the plurality of counterfactual scenarios using the counterfactual agentic AI model. The counterfactual agentic AI model may include the Gen AI model 122. The counterfactual agentic AI model may generate counterfactual stepwise reasoning paths corresponding to each counterfactual scenario. In an example, the counterfactual agentic AI model may refer to an agentic AI model configured to execute the sequence of dynamically determined evaluation instructions on the plurality of counterfactual scenarios to generate corresponding counterfactual stepwise reasoning paths. For example, the counterfactual agentic AI model may process the modified claim attributes, such as, but not limited to, a changed diagnosis code and/or adjusted billed amount, to determine whether the final claim result varies under a plurality of alternative scenarios. Further, the processor 106 may be configured to compute a decision stability score representing a proportion of the plurality of counterfactual scenarios to generate a claim result distinct from the final claim result. In an example, the decision stability score may generate a claim result distinct from the final claim result. The decision stability score may indicate reliability of the final claim result with respect to variations in claim attributes and policy conditions. For example, when a majority of the plurality of counterfactual scenarios result in a same claim disposition, the decision stability score may indicate a high stability. Further, when one or more scenarios result in a plurality of different outcomes, the decision stability score may indicate low stability. Furthermore, the processor 106 may be configured to generate the explanation data for the decision stability score. The explanation data may include a sensitivity profile identifying insurance-related data attributes frequently altering the final claim result across the plurality of counterfactual scenarios.

In another example, the processor 106 may be configured to retrieve a longitudinal causal profile for a claimant from the at least one policy database. The longitudinal causal profile may include prior claim data, treatment trajectories, and standard-of-care guidelines obtained from the one or more insurance policy documents. In an example, the longitudinal causal profile may refer to historical and contextual data associated with a claimant over time including the prior claim data, the treatment trajectories, and the standard-of-care guidelines. The longitudinal causal profile may include, such as, for example, but not limited to, one or more previous treatments for a condition and expected recovery timelines used to assess consistency of a current claim. In another example, the claimant may refer to an individual for whom the insurance claim may be submitted. For example, the claimant may be a patient receiving medical treatment and seeking reimbursement under an insurance policy. In another example, the at least one policy database may refer to a repository storing one or more insurance policy documents and related data. For example, the at least one policy database may store at least one of one or more coverage rules, one or more exclusions, and the standard-of-care guidelines used for the claim adjudication.

The processor 106 may be configured to evaluate a causal consistency level between the final claim result, the stepwise reasoning path, and the longitudinal causal profile using the causal discrepancy agentic AI model including the Gen AI model 122. In an example, the causal consistency level may refer to a degree of alignment between a final claim result, a stepwise reasoning path, and a longitudinal causal profile. For example, the causal consistency level may indicate whether a treatment claimed may align with an expected treatment progression for a diagnosed condition. Further, the processor 106 may be configured to compute a causal consistency score representing an alignment between the final claim result and expected causal trajectories implied by the longitudinal causal profile and policy guidelines. In another example, the causal discrepancy agentic Artificial Intelligence (AI) model may refer to an agentic Artificial Intelligence (AI) model configured to evaluate a causal consistency between the final claim result and the longitudinal causal profile using one or more Generative Artificial Intelligence (Gen AI) models. For example, the causal discrepancy agentic Artificial Intelligence (AI) model may analyze whether a claimed surgical procedure may logically follow a plurality of prior treatments. In another example, the causal consistency score may refer to a metric generated using the causal discrepancy agentic AI model including the Gen AI model 122. The causal consistency score may represent an extent of alignment between the final claim result and the expected causal trajectories. For example, a high score of the causal consistency score may indicate that the claim may follow a standard treatment progression. Further, a low score of the causal consistency score may indicate an inconsistency requiring further review of the insurance claim.

In another example, to evaluate the causal consistency level between the final claim result, the stepwise reasoning path, and the longitudinal causal profile using the causal discrepancy agentic AI model, the processor 106 may be configured to determine whether the final claim result and dynamically determined evaluation instructions may be causally consistent with at least one of a historical treatment results of the claimant, normative recovery timelines encoded in the one or more insurance policy documents, and prerequisite procedure requirements from prior claims. In an example, the historical treatment results of the claimant may refer to outcomes of a plurality of prior medical treatments associated with the claimant. The historical treatment results may include, such as, for example, but not limited, one or more records indicating recovery status, one or more prior procedures performed, and/or an effectiveness of one or more earlier treatments for a diagnosed condition. In another example, the normative recovery timelines may refer to one or more expected durations for recovery from at least one of one or more specific medical conditions and/or one or more procedures as defined in the one or more insurance policy documents. The one or more insurance policy documents may specify a standard recovery period for a surgical procedure. Further, the one or more insurance policy documents, which may be used to assess whether a claimed follow-up treatment aligns with one or more expected timelines. In another example, the prerequisite procedure requirements from the prior claims may refer to at least one of one or more required prior treatments and/or one or more procedures. Further, the prerequisite procedure requirements may be expected before a current procedure may be considered valid under the insurance policy. For example, a policy may require a conservative treatment such as, but not limited to, a medication and/or a therapy before approving a surgical procedure. Further, the policy may require an absence of the surgical procedures may indicate an inconsistency in the claim.

In another example, the processor 106 may be configured to receive, via the user interface, a human reviewer feedback on previously adjudicated claims. The human reviewer feedback may include overrides of final claim results and annotations to specific policy sections. In an example, the human reviewer feedback may refer to inputs provided by the user reviewing previously adjudicated claims. For example, human reviewer feedback may override a denial to approval and annotate a specific policy clause supporting the decision. The processor 106 may be configured to generate a reviewer preference profile for the at least one user based on the human reviewer feedback. The reviewer preference profile may include one or more distributions over policy interpretation preferences and rationale generation patterns aligned with the one or more insurance policy documents. Further, the reviewer preference profile may be generated by filtering the human reviewer feedback to extract one or more reviewer behaviors consistent with policy guidelines in the one or more insurance policy documents. Furthermore, the reviewer preference profile may be generated by encoding the filtered one or more reviewer behaviors as preference vectors applied to prompts of the reasoning agent 120. In an example, the preference vectors may refer to one or more encoded representations of the one or more reviewer behaviors and the policy interpretation preferences applied to the prompts of the reasoning agent 120 to influence evaluation and explanation generation. For example, the preference vectors may adjust weighting of specific policy clauses during reasoning. In another example, the alignment delta indicator may refer to a representation of differences between the stepwise reasoning path generated without the reviewer preferences and a modified reasoning path generated based on the reviewer preference profile. For example, the alignment delta indicator may highlight that a claim decision changed due to application of a reviewer-preferred policy interpretation. In another example, the modifications may refer to changes applied to the stepwise reasoning path and/or the explanation data based on the reviewer preference profile. Further, the modifications may include, such as, for example, but not limited to, altering evaluation instructions, prioritizing specific policy clauses, or adjusting explanation content to reflect reviewer-aligned reasoning. In another example, the reviewer preference profile may refer to a representation of the policy interpretation preferences and the rationale generation patterns associated with the at least one user, derived from the human reviewer feedback. For example, the reviewer preference profile may indicate that a reviewer may frequently prioritize one or more policy clauses. Further, the reviewer preference profile may indicate that the reviewer may apply a stricter medical necessity criteria. In another example, the one or more reviewer behaviors may refer to the rationale generation patterns observed from the human reviewer feedback, including, such as, for example, btu not limited to, one or more decision overrides, one or more annotation patterns, and one or more policy interpretation tendencies. For example, the one or more reviewer behaviors may include, such as, but not limited to, consistently approving the insurance claim under at least one of a specific coverage condition and/or a frequently flagging certain exclusion. Furthermore, the processor 106 may be configured to generate one or more conditions for the stepwise reasoning path and an explanation data based on the reviewer preference profile associated with the at least one user. In addition, the processor 106 may be configured to embed an alignment delta indicator in the explanation data. The alignment delta indicator may represent modifications to the stepwise reasoning path based on the reviewer preference profile.

In another example, the processor 106 may be configured to determine a fragility threshold value for the insurance claim based on a decision stability score and a causal consistency score. In an example, the fragility threshold value may refer to a threshold metric used to determine whether the final claim result may require an escalation for an external review based on reliability and consistency of the decision. For example, when the fragility threshold value may indicate a low reliability due to a high variation in outcomes and/or a low causal alignment, the insurance claim may be flagged for review. In another example, the decision stability score and the causal consistency score may refer to metrics used to evaluate a reliability and a causal validity of the final claim result. The decision stability score may indicate a sensitivity of the claim result to variations in the plurality of counterfactual scenarios. Further, the causal consistency score may indicate alignment of the claim result with one or more expected treatment trajectories. For example, a low decision stability score and a low causal consistency score may indicate that the claim outcome may be uncertain and inconsistent with prior treatment patterns. The processor 106 may be configured to trigger an escalation process for the insurance claim for external review via the user interface when the fragility threshold value may be exceeded. Further, the processor 106 may be configured to embed the explanation data augmented with a plurality of counterfactual scenarios, causal discrepancies, and reviewer preference alignments to an escalated insurance claim. In another example, the plurality of counterfactual scenarios, the causal discrepancies, and the reviewer preference alignments may refer to supplementary information embedded within the explanation data to provide the escalated insurance claim. The plurality of counterfactual scenarios may represent alternative claim variations, the causal discrepancies may indicate inconsistencies between the claim and expected treatment progression, and the reviewer preference alignments may reflect adjustments based on the one or more reviewer behaviors. For example, the explanation data may include a plurality of alternative outcomes. The plurality of alternative outcomes may be under modified claim attributes, identified mismatches with standard treatment timelines, and reasoning adjustments influenced by the reviewer preference.

In another example, to validate the output of the executed sequence of dynamically determined evaluation instructions, the processor 106 may be configured to cross-validate the outputs from the plurality of agentic AI models 104 with a plurality of counterfactual scenarios and a longitudinal causal profile. In an example, the dynamically determined evaluation instructions may refer to instructions generated by the reasoning agent 120 based on extracted insurance-related data and one or more contextually relevant policy sections. The instructions may correspond to policy interpretation steps for adjudicating the insurance claim. The dynamically determined evaluation instructions may be generated and updated in a context-specific and iterative manner during execution. Further, the dynamically determined evaluation instructions may include, such as, for example, but not limited to, verifying a coverage eligibility of a procedure based on a diagnosis code. The dynamically determined evaluation instructions may include applying an exclusion clause from a policy document, evaluating medical necessity criteria. Further, the dynamically determined evaluation instructions may include calculating a payable amount based on policy limits. The sequence of instructions may vary depending on claim attributes and the retrieved policy conditions.

In another example, the processor 106 may be configured to receive multimodal external evidence data from one or more external data sources (not depicted in FIG. 2). The multimodal external evidence data may include at least one of social media activity data, geolocation data, public records data, and biometric log data associated with the claimant. In an example, the multimodal external evidence data may refer to data obtained from a plurality of external modalities associated with the claimant. The multimodal external evidence data may include, such as, for example, but not limited to, one or more location logs indicating claimant presence, one or more public records indicating an employment status, and an activity data inconsistent with a claimed medical condition. In another example, the one or more external data sources may refer to systems and/or platforms from which the multimodal external evidence data may be retrieved. The one or more external data sources may include, such as, for examples, but not limited to, one or more social media platforms, one or more geolocation services, one or more government databases, one or more wearable devices, and one or more third-party data providers. The processor 106 may be configured to generate a trust graph representing behavioral relationships and physical relationships between the insurance-related data and the multimodal external evidence data using a multimodal evidence cross-correlation agentic AI model. The trust graph may include nodes representing at least one of activity level indicators, physical location patterns, claim detail entities, and cross-domain evidence entities obtained from the multimodal external evidence data. In an example, the trust graph may refer to a graph-based representation of relationships between the insurance-related data and the multimodal external evidence data. The trust graph may include the nodes representing claim entities and external evidence entities. Further, the nodes may represent edges representing relationships such as, for example, but not limited to, a temporal correlation, a spatial proximity, and/or a behavioural consistency. For example, the trust graph may link a claimed hospitalization period with a geolocation data indicating a movement outside a hospital. In another example, the multimodal evidence cross-correlation agentic Artificial Intelligence (AI) model may refer to an agentic AI model. The multimodal evidence cross-correlation agentic Artificial Intelligence (AI) model may be configured to correlate and integrate multimodal external evidence data with insurance-related data to generate the trust graph. For example, the multimodal evidence cross-correlation agentic Artificial Intelligence (AI) model may correlate one or more timestamps of a social media activity with one or more claim dates to identify inconsistencies. Further, the processor 106 may be configured to compute a Bayesian claim anomaly score representing a posterior probability of anomalous behavior indicated in the trust graph and a stepwise reasoning path generated by the reasoning agent 120 using the Bayesian anomaly agentic AI model. In an example, the Bayesian claim anomaly score may refer to a probabilistic score representing a likelihood of anomalous behaviour associated with an insurance claim based on the trust graph and the stepwise reasoning path. For example, when the Bayesian claim anomaly score may be high, which may indicate a potential inconsistency between a claimed treatment and an observed external evidence. In another example, the Bayesian anomaly agentic Artificial Intelligence (AI) model may refer to an agentic AI model. The Bayesian anomaly agentic Artificial Intelligence (AI) model may be configured to compute the Bayesian claim anomaly score using a probabilistic inference based on relationships represented in the trust graph. For example, the Bayesian anomaly agentic Artificial Intelligence (AI) model may evaluate deviations between an expected claimant behaviour and an observed external evidence to determine a likelihood of an anomaly.

In another example, to generate the trust graph representing the behavioral relationships and the physical relationships between the insurance-related data and the multimodal external evidence data, the processor 106 may be configured to correlate temporal patterns and spatial patterns in the multimodal external evidence data with timestamps and locations encoded in the extracted insurance-related data. In an example, the temporal patterns may refer to time-based activity trends, and the spatial patterns may refer to location-based movement or presence associated with a claimant. For example, the temporal patterns may include timestamps of social media activity. Further, the spatial patterns may include a geolocation data indicating movement across locations. In another example, the timestamps and the locations encoded in the extracted insurance-related data may refer to time and place information associated with claim events. For example, the extracted insurance-related data may include a date of hospitalization and a location of a healthcare facility where treatment is claimed to have occurred. The processor 106 may be configured to establish directed edges in the trust graph between claim detail nodes and external evidence nodes based on at least one of a co-occurrence in time, a spatial proximity, and a behavioral inconsistency level with expected claimant profiles implied by the one or more insurance policy documents. In an example, the directed edges may refer to connections established in the trust graph indicating relationships between the claim detail nodes and the external evidence entities. For example, a directed edge may connect a hospitalization node to a geolocation node indicating presence outside a hospital during the claimed treatment period. In another example, the co-occurrence in time may refer to events occurring within a similar time period. Further, the spatial proximity may refer to closeness of locations. Furthermore, the behavioural inconsistency level may refer to deviation from an expected behaviour based on policy guidelines and/or claimant profiles. For example, the co-occurrence in time may include matching timestamps between a claim and external activity. Further, the spatial proximity may include presence near a healthcare facility. Furthermore, the behavioural inconsistency may include an activity inconsistent with a claimed medical condition.

In another example, to compute the Bayesian claim anomaly score, the processor 106 may be configured to determine a deviation between policy-driven conclusions in the stepwise reasoning path and behavioral patterns encoded in the trust graph. In an example, the deviation between the policy-driven conclusions may refer to a difference between outcomes derived from the stepwise reasoning path based on the one or more insurance policy documents and the behavioural patterns represented in the trust graph. The policy-driven conclusions may indicate, such as, for example, but not limited to, an approval of the insurance claim. Further, the policy-driven conclusions may include an external evidence may indicate an inconsistent claimant activity, resulting in the deviation between the policy-driven conclusions. The processor 106 may be configured to determine if the Bayesian claim anomaly score exceeds a predefined anomaly threshold value. Further, the processor 106 may be configured to apply the Bayesian claim anomaly score at a decision junction to override the final claim result generated based on the stepwise reasoning path and based on the determined deviation, if the Bayesian claim anomaly score exceeds a predefined anomaly threshold value. The override may generate a modified final claim result comprising at least one of a denial, a flag for manual review, and an escalated approval requirement. In an example, the decision junction may refer to a logical evaluation point at which the Bayesian claim anomaly score may be applied to determine whether to override the final claim result. For example, the decision junction may evaluate whether the anomaly score may exceed a predefined threshold before modifying the claim outcome. In another example, the predefined anomaly threshold value may refer to a preset value used to determine whether the Bayesian claim anomaly score may indicate an anomalous behaviour. For example, when the anomaly score may exceed the predefined threshold, the insurance claim may be flagged for a further action. In another example, the denial may indicate a rejection of the insurance claim. Further, the flag for manual review may indicate requirement for a human evaluation. Furthermore, the escalated approval requirement may indicate a conditional approval subject to additional verification. For example, the insurance claim may be flagged for manual review when the anomaly may be detected. Further, the insurance claim may be denied when a strong inconsistency may be observed. Furthermore, the processor 106 may be configured to generate override rationale data comprising an original stepwise reasoning path and a justification data for the Bayesian claim anomaly score. In an example, the original stepwise reasoning path may refer to the sequence of evaluation steps generated prior to applying the Bayesian claim anomaly score. Further, the justification data may refer to an explanatory information supporting the anomaly-based override. For example, the justification data may include references to inconsistencies identified in the trust graph and reasons for modifying the final claim result.

In another example, the explanation data for overridden claims may include a multi-panel visualization. The multi-panel visualization may include a primary stepwise reasoning path, a graphical representation of the trust graph, the Bayesian claim anomaly score, and an override decision junction logic. In an example, the overridden claims may refer to insurance claims for which the final claim result generated based on the stepwise reasoning path model may be modified using the Bayesian claim anomaly score at the decision junction. For example, the claim initially approved based on a policy evaluation may be overridden to a denial and/or flagged for a manual review due to an anomalous behaviour identified from the trust graph. In another example, the multi-panel visualization may refer to a structured visual representation of explanation data. The structured visual representation of explanation data may include one or more panels displaying a plurality of different aspects of the claim adjudication. Further, the multi-panel visualization may include, such as, for example, but not limited to, one or more separate panels showing the reasoning path, the trust graph, the Bayesian claim anomaly score, and the override decision logic for providing a user interpretation. In another example, the primary stepwise reasoning path may refer to a sequence of policy interpretation steps generated prior to any override of the final claim result. The primary stepwise reasoning path may include steps, such as, for example, but not limited to, verifying coverage eligibility, evaluating medical necessity, and determining a payable amount. In another example, the graphical representation of the trust graph may refer to a visual depiction of nodes and edges representing relationships between the insurance-related data and the multimodal external evidence data. For example, the graphical representation may display links between claim details and geolocation data indicating potential inconsistencies. In another example, the override decision junction may refer to a logical point at which a decision to modify the final claim result may be made based on the Bayesian claim anomaly score. Further, the override decision junction may determine whether to maintain an original claim decision and/or apply an override such as denial and/or escalation based on the anomaly score exceeding the predefined threshold.

In another example, to extract the insurance‑related data from the input data using the first Generative Artificial Intelligence (Gen AI) model 118, the processor 106 may be configured to generate one or more tokens corresponding to textual portions of the input data using the first Gen AI model 118. The textual portions may include at least one of free‑text treatment descriptions, provider notes, and claimant notes. In an example, the one or more tokens may refer to one or more segmented units of the textual portions of the input data generated by the first Gen AI model 118. For example, a free-text treatment description may be divided into the one or more tokens representing at least one of medical terms, procedures, and conditions. The processor 106 may be configured to identify entities corresponding to at least one of diagnoses, procedures, body parts, medications, and dates by determining at least one a named‑entity data in the generated one or more tokens. In an example, the generated one or more tokens may refer to output units produced by processing textual portions using the first Gen AI model 118 for further analysis. The one or more tokens may include, such as, for example, but not limited to, one or more words and/or one or more phrases extracted from the provider notes for an entity identification. Further, the processor 106 may be configured to map the identified entities to the standardized diagnosis codes and procedure codes using one or more medical coding ontologies and based on the first Gen AI model 118. In an example, the standardized diagnosis codes and the procedure codes may refer to one or more normalized coding representations of one or more medical conditions and one or more procedures derived from the identified entities. For example, a diagnosis may be mapped to the standardized diagnosis codes and the procedure codes may be mapped to a corresponding procedure code. In another example, the one or more medical coding ontologies may refer to one or more structured coding systems used for mapping the identified entities to the standardized diagnosis codes. The one or more medical coding ontologies may include, such as, for example, but not limited to, one or more coding systems. The one or more coding systems may include, such as, for example, but not limited to, International Classification of Diseases (ICD) for diagnoses and Current Procedural Terminology (CPT) for procedures. Furthermore, the processor 106 may be configured to parse structured fields of the claim data, the claimant attributes, and provider information to obtain the structured claim attributes using the first Gen AI model 118. The structured claim attributes may include at least one of normalized codes, normalized amounts, and normalized dates. In addition, the processor 106 may be configured to determine the unstructured claim attributes using the first Gen AI model 118. The unstructured claim attributes may include at least one of an inferred severity, an inferred place of service, an inferred claim context, and narrative treatment descriptions from the textual portions. In an example, the inferred severity may refer to a derived level of medical condition seriousness. The inferred place of service may refer to a derived treatment setting such as hospital and/or outpatient facility. The inferred claim context may refer to a derived situation such as emergency and/or elective treatment, and narrative treatment descriptions may refer to textual descriptions of medical services. For example, the inferred severity may be inferred as high based on clinical notes, place of service may be inferred as inpatient, and claim context may be inferred as emergency. Further, the processor 106 may be configured to output the structured claim attributes and the unstructured claim attributes as the extracted insurance‑related data in an insurance‑related data object. In an example, the extracted insurance-related data may refer to a combination of the at least one of the structured claim attributes and the unstructured claim attributes obtained from the input data using the first Gen AI model 118. The extracted insurance-related data may include, such as, for example, but not limited to, one or more normalized codes, one or more treatment descriptions, and one or more inferred contextual attributes. In another example, the insurance-related data object may refer to a structured representation of the extracted insurance-related data for further processing by the system. The insurance-related data object may include, such as, for example, but not limited to, one or more fields for at least one of the diagnosis codes, procedure codes, treatment details, and contextual attributes organized in a machine-readable format.

In another example, to generate the sequence of dynamically determined evaluation instructions for adjudicating the insurance claim using the reasoning agent 120, the processor 106 may be configured to generate a contextual query from at least a subset of the extracted insurance‑related data using the reasoning agent 120. The contextual query may include the diagnosis codes, procedure codes, and contextual claim attributes. The processor 106 may be configured to retrieve the one or more contextually relevant policy sections from the at least one policy database by applying the contextual query to the one or more insurance policy documents using the reasoning agent 120. Further, the processor 106 may be configured to segment the retrieved one or more contextually relevant policy sections into a plurality of policy clauses using the reasoning agent 120. Each policy clause may correspond to at least one of a coverage condition, an exclusion, a limitation, and a medical necessity requirement. Furthermore, the processor 106 may be configured to determine a subsequent evaluation operation by applying a stepwise chain‑of‑thought reasoning process over the extracted insurance‑related data and the plurality of policy clauses using the reasoning agent 120. In addition, the processor 106 may be configured to generate an evaluation instruction corresponding to the determined subsequent evaluation operation. The evaluation instruction may include at least one of a policy clause identifier, a required input parameter, and an expected output parameter. Further, the processor 106 may be configured to append the generated evaluation instruction to the sequence of dynamically determined evaluation instructions. Furthermore, the processor 106 may be configured to iteratively repeat the process of determining, generating, and appending until the policy interpretation steps required by the retrieved contextually relevant policy sections is being covered.

In another example, to identify the plurality of agentic Artificial Intelligence (AI) models 104 for executing the sequence of the dynamically determined evaluation instructions, the processor 106 may be configured to obtain metadata corresponding to the plurality of agentic Artificial Intelligence (AI) models 104 from a database. The metadata may include capabilities of each of the plurality of agentic AI models 104. The capabilities may include at least one of input types, output types, and associated policy evaluation functions. The processor 106 may be configured to identify an operation type and one or more required inputs by parsing each evaluation instruction in the sequence of dynamically determined evaluation instructions using the reasoning agent 120. Further, the processor 106 may be configured to select at least one agentic AI model for each parsed evaluation instruction based on the capabilities of agentic AI model satisfying the identified operation type and the one or more required inputs. Furthermore, the processor 106 may be configured to map each evaluation instruction to the selected at least one agentic AI model. The selected agentic AI model may include at least one of the data extraction agent, the policy evaluation agent, and the reasoning agent 120.

In another example, to execute the sequence of the dynamically determined evaluation instructions by selectively applying the sequence at the identified plurality of agentic AI models, the processor 106 may be configured to execute the identified agentic AI model with input parameters for each evaluation instruction. The input parameters may include at least a portion of the extracted insurance‑related data and intermediate results from previously executed evaluation instructions. The processor 106 may be configured to receive an evaluation result as an output from the agentic AI model. The evaluation result may include at least one of a Boolean decision, a numerical value, a classification label, and an extracted data field. Further, the processor 106 may be configured to update a claim evaluation state database with the received evaluation result in association with the evaluation instruction. Furthermore, the processor 106 may be configured to output the updated claim evaluation state database as a context to a subsequent evaluation instruction in the sequence.

In another example, to validate the output of the identified plurality of agentic AI models based on the executed sequence of the dynamically determined evaluation instructions, the processor 106 may be configured to aggregate evaluation results generated by each of the plurality of agentic AI models 104 into a consolidated result set. The processor 106 may be configured to determine whether the evaluation results for each evaluation instruction satisfies one or more predefined consistency checks, wherein the one or more predefined consistency checks comprise at least one of range checks, type checks, and logical dependency checks. Further, the processor 106 may be configured to detect conflicts between the evaluation results corresponding to a plurality of evaluation instructions and prestored result corresponding to one of a similar policy clause and a similar claim attribute. Furthermore, the processor 106 may be configured to assign a confidence score to each evaluation result based on at least one of a source agentic AI model type, a historical performance metric, and the detected conflicts. In addition, the processor 106 may be configured to generate a validation result object indicating at least one of validated evaluation results, flagged evaluation results, and associated confidence scores.

In another example, to determine the one or more actions for the claim adjudication using the stepwise reasoning path model and the results of validation, the processor 106 may be configured to generate the stepwise reasoning path model representing nodes corresponding to the evaluation instructions and edges corresponding to dependencies between the evaluation results. The processor 106 may be configured to annotate the nodes of the stepwise reasoning path model with a validation result object. The validation result object may include validated evaluation results and flagged evaluation results. Further, the processor 106 may be configured to identify points in a stepwise reasoning path requiring information by traversing the stepwise reasoning path model based on a predefined traversal strategy. Furthermore, the processor 106 may be configured to determine the one or more actions for the claim adjudication at each of the identified points. The one or more actions may include at least one of retrieving additional claim data, generating external application programming interfaces (APIs), and refining a policy evaluation by regenerating and adjusting one or more evaluation instructions. In addition, the processor 106 may be configured to generate an action plan for each determined action. The action plan may include an associated target data source, external API endpoint, and a condition for executing the action.

In another example, to generate the final claim result based on the stepwise reasoning path model and the determined one or more actions, the processor 106 may be configured to execute an action plan by performing the retrieval of additional claim data, generating the external APIs, and refining the policy evaluation until the stepwise reasoning path model indicates completion of required actions. The processor 106 may be configured to update the stepwise reasoning path model to reflect results of the executed actions. Further, the processor 106 may be configured to determine a claim disposition result. The claim disposition result may include at least one of an approval, a denial, and a pending status based on a terminal state of the updated stepwise reasoning path model. Furthermore, the processor 106 may be configured to calculate a payable amount based on covered services, applicable deductibles, copayments, and coinsurance as indicated by the evaluation results represented in the stepwise reasoning path model. In addition, the processor 106 may be configured to generate the final claim result. The final claim result may include at least one of the claim disposition result and the calculated payable amount.

In another example, to output the final claim result and the explanation data corresponding to the final result on the user interface of the user device 112, the processor 106 may be configured to generate a structured explanation object by mapping a relevant subset of the nodes and edges of the stepwise reasoning path model with the final claim result and map identifiers of the one or more insurance policy documents and the corresponding policy sections with each of the subset of the nodes. The processor 106 may be configured to generate a natural language explanation segment for each of the subset of the nodes. The natural language explanation segment may include a description of a corresponding policy interpretation step and corresponding result. Further, the processor 106 may be configured to embed the natural language explanation segment into the explanation data along with references to the one or more insurance policy documents and the stepwise reasoning path model.

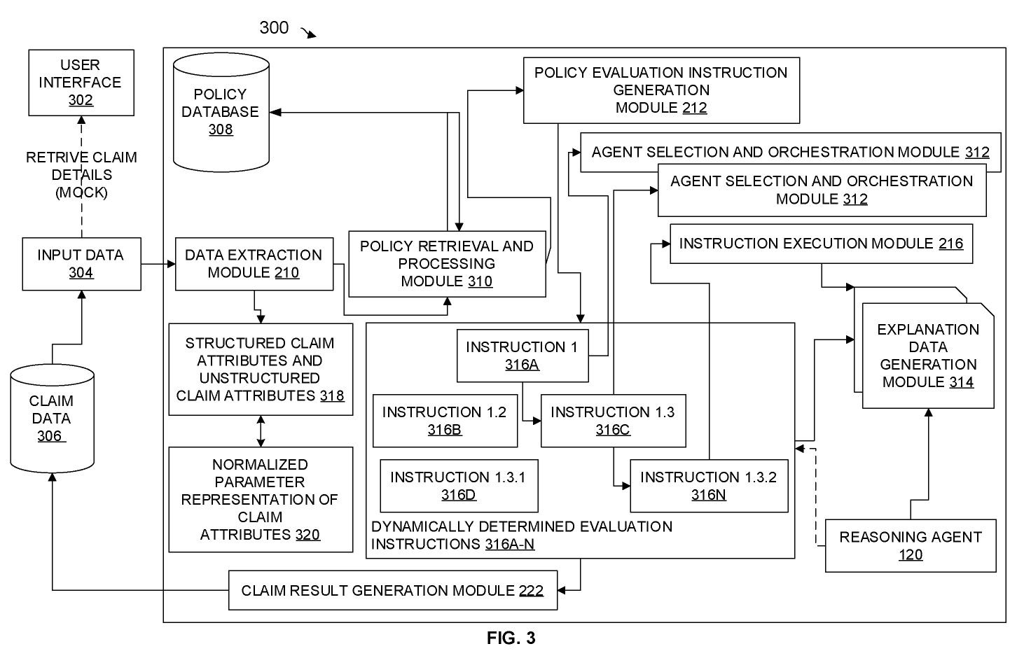

FIG. 3 illustrates an exemplary schematic representation of a system architecture 300 of the computer-implemented system 102, according to an embodiment of the present invention, according to an example. The computer-implemented system 102 may receive the input data 304, including the claim data 306, via the user interface 302. Further, the computer-implemented system 102 may process the input data 304 using the data extraction module 210 to generate at least one of the structured claim attributes and the unstructured claim attributes 318 along with one or more normalized parameter representations of claims attributes 320. The computer-implemented system 102 may further obtain one or more contextually relevant policy sections from the at least one policy database 308 using a policy retrieval and processing module 310. Further, the computer-implemented system 102 may generate the sequence of dynamically determined evaluation instructions 316A-N using the policy evaluation instruction generation module 212. Further, an agent selection and orchestration module 312 may identify the plurality of agentic AI models 104 for executing the generated evaluation instructions. Furthermore, the instruction execution module 216 may execute the generated evaluation instructions, including performing actions via the one or more external APIs and database lookups. Further, the reasoning agent 120 including the Gen AI model 122 may generate a stepwise reasoning path and explanation data using an explanation data generation module 314. Furthermore, the claim result generation module 222 may generate the final claim result based on execution results. The computer-implemented system 102 may log actions and instructions to provide traceability. In addition, the computer-implemented system 102 may output the final claim result along with the explanation data.

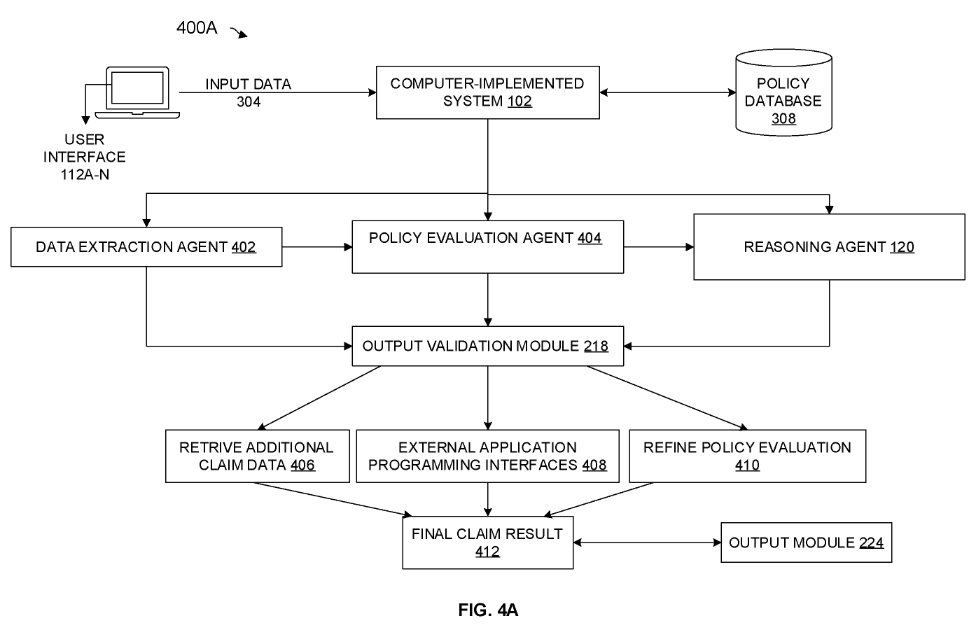

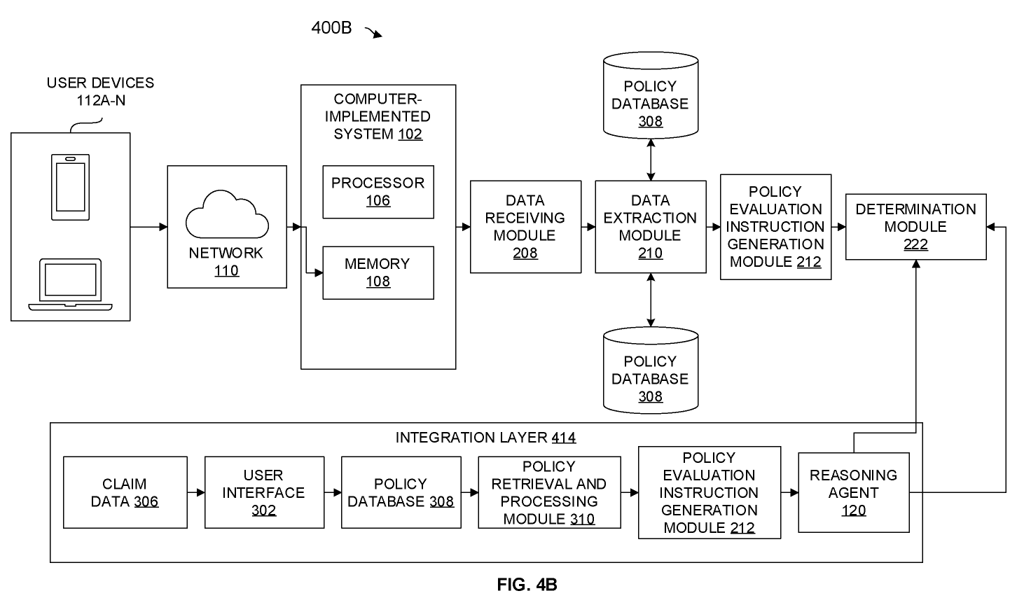

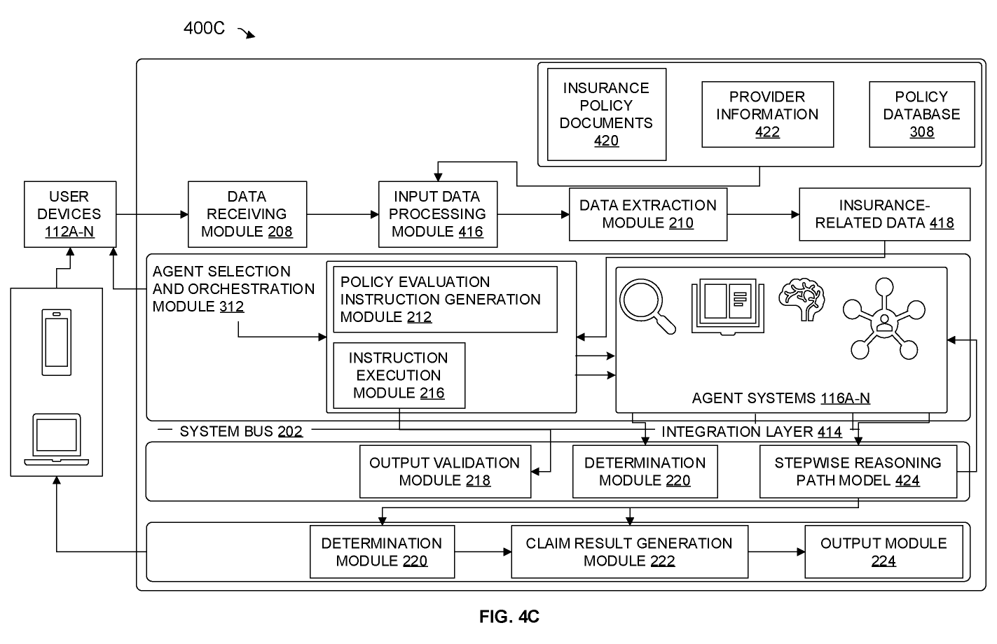

FIGS. 4A-4C illustrate exemplary schematic diagram representations depicting operational configurations of the computer-implemented system 102 for generating the final claim result and the explanation data for the insurance claim, according to an example.

According to FIG. 4A, an exemplary schematic diagram representation depicting an operational configuration 400A of the computer-implemented system 102 for generating the final claim result and the explanation data for the insurance claim. The input data 304 corresponding to the insurance claim may be received from the one or more user devices 112A-N. Further, the input data 304 may be provided to the computer-implemented system 102, which may be communicatively coupled with the at least one policy database 308. The computer-implemented system 102 may include a data extraction agent 402. The data extraction agent 402 may be configured to extract the insurance-related data using the one or more Large Language Models (LLMs). Further, the policy evaluation agent 404 may be configured to generate the policy interpretation steps using a policy interpretation model. The reasoning agent 120 may be configured to generate the sequence of dynamically determined evaluation instructions 316A-N using a dynamic reasoning model. Further, outputs from the plurality of agentic AI models 104 may be provided to the output validation module 218. The output validation module 218 may be configured to perform validation and decision logic. Based on the validation and decision logic, one or more actions may be determined, including obtaining additional claim data 406, invoking one or more external application programming interfaces (APIs) 408, and refining policy evaluation 410. The computer-implemented system 102 may generate the final claim result 412 based on the validated outputs and the determined one or more actions. Further, the final claim result 412 may be provided to the output module 224 for presenting the final claim result 412 and the explanation data on the user interface 302.

According to FIG. 4B, an exemplary schematic diagram representation depicting an operational configuration 400B of the computer-implemented system 102 for generating the final claim result 412 and the explanation data for the insurance claim. Further, the input data 304 may be received from the one or more user devices 112A-N via the network 110. Furthermore, the input data 304 may be processed by the computer-implemented system 102 including the processor 106 and the memory 108. The data receiving module 208 may be configured to receive the input data 304. Further, the data extraction module 210 may be configured to extract the insurance-related data. Furthermore, the policy evaluation instruction generation module 212 may be configured to generate the sequence of dynamically determined evaluation instructions 316A-N based on one or more contextually relevant policy sections. The one or more contextually relevant policy sections may be obtained from the at least one policy database 308. Further, the determination module 220 may be configured to determine the one or more actions for claim adjudication. Furthermore, an integration layer 414 may provide communication among components including the claim data 306, the user interface 302, the at least one policy database 308, the policy retrieval and processing module 310, the policy evaluation instruction generation module 212, and the reasoning agent 120. Further, the reasoning agent 120 may be configured for generating a stepwise reasoning path. The plurality of modules 206 may operate in coordination to process the insurance claim. Further, the plurality of modules 206 may generate the final claim result 412 along with the explanation data.

According to FIG. 4C, an exemplary schematic diagram representation depicting an operational configuration 400C of the computer-implemented system 102 for generating the final claim result 412 and the explanation data for the insurance claim. The input data 304 may be received from the one or more user devices 112A-N. Further, the input data 304 may be processed by the data receiving module 208 and an input data processing module 416. Further, the data extraction module 210 may be configured to extract the insurance-related data 418 from one or more sources. The one or more sources may include, such as, for example, but not limited to, the one or more insurance policy documents 420, the provider information 422, and the at least one policy database 308. Further, the agent selection and orchestration module 312 may identify the plurality of agent systems 116A-N, and the policy evaluation instruction generation module 212 along with the instruction execution module 216 may generate and execute the sequence of dynamically determined evaluation instructions 316A-N. The computer-implemented system 102 may include the system bus 202 and the integration layer 414 for providing communication among components, including the plurality of agent systems 116A-N. Further, the output validation module 218 may validate outputs. Furthermore, the determination module 220 may determine the one or more actions and generate the stepwise reasoning path model 424. Further, the claim result generation module 222 may generate the final claim result 412 based on the validated outputs and determined actions. The final claim result 412 may be provided via the output module 224 to present the final claim result 412 and the explanation data.

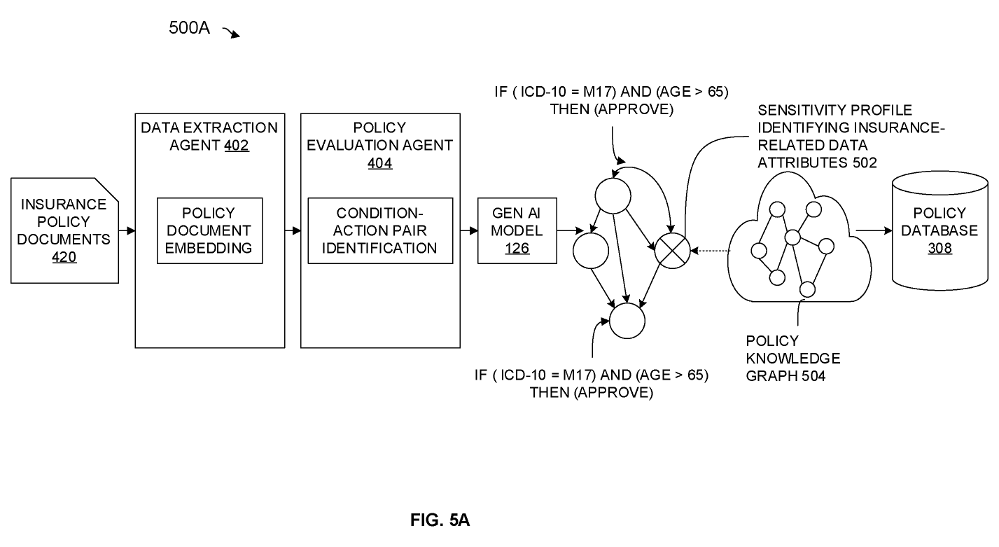

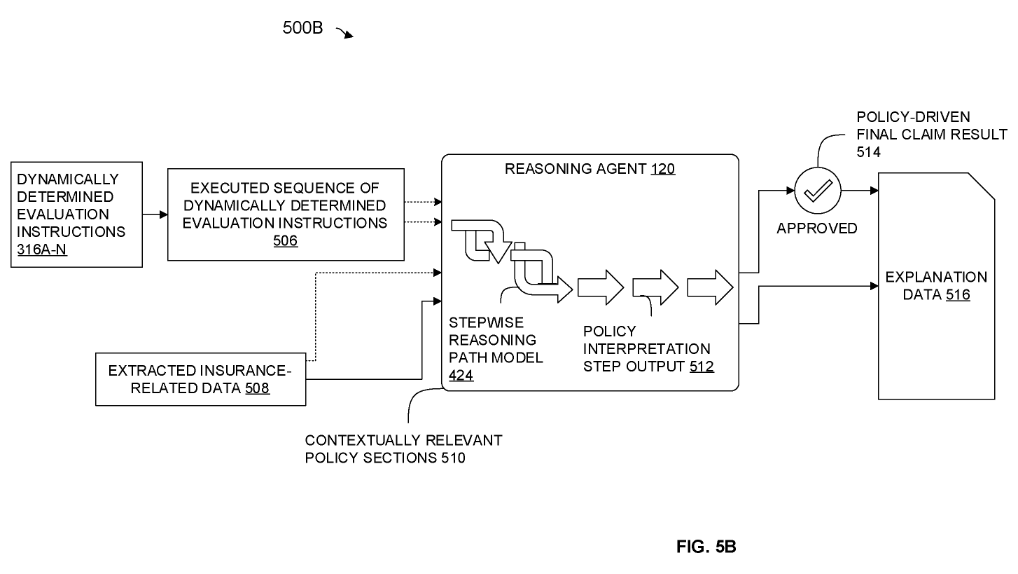

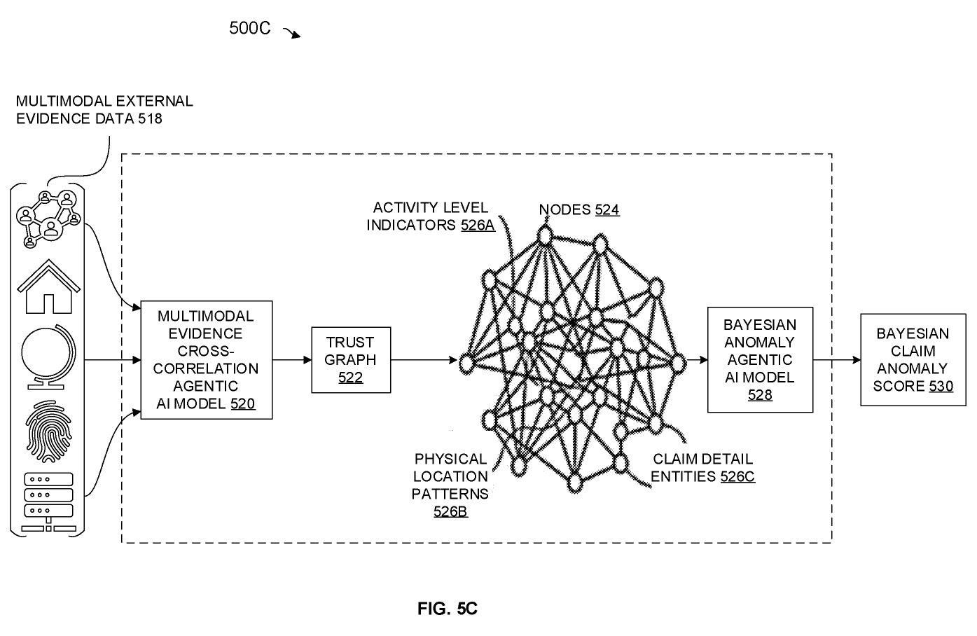

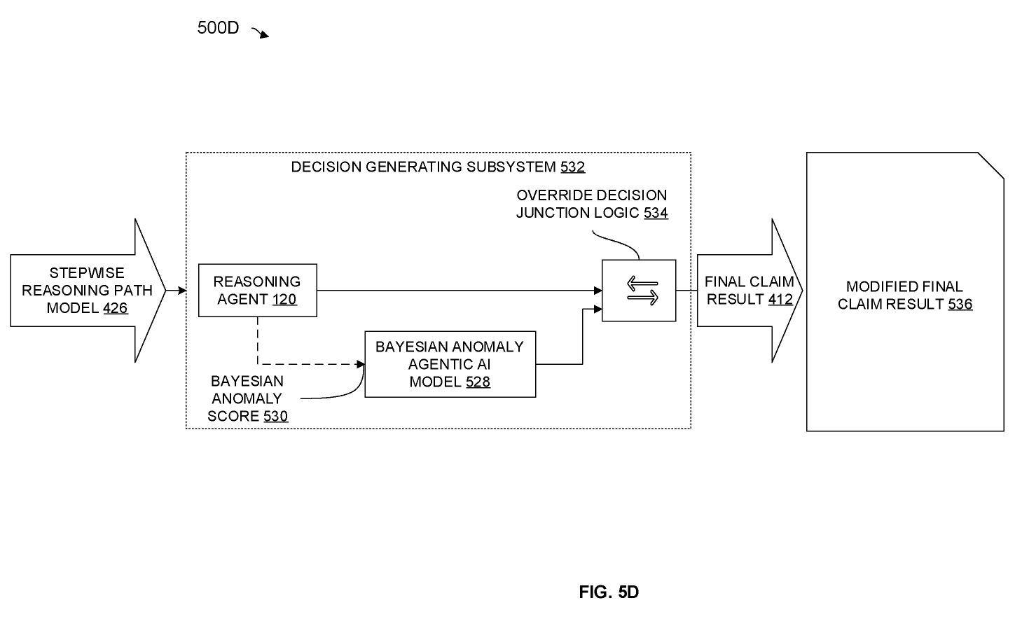

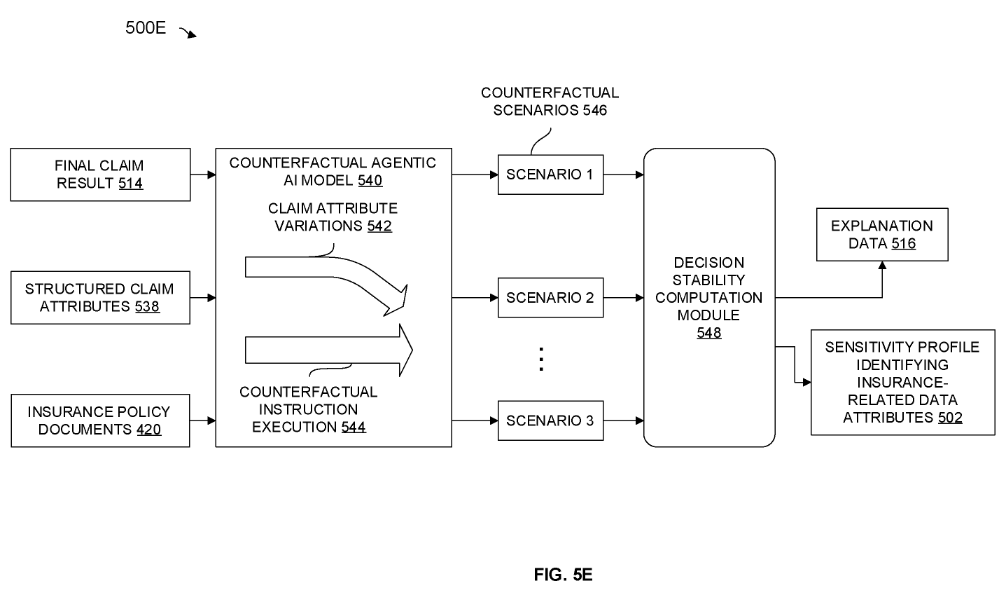

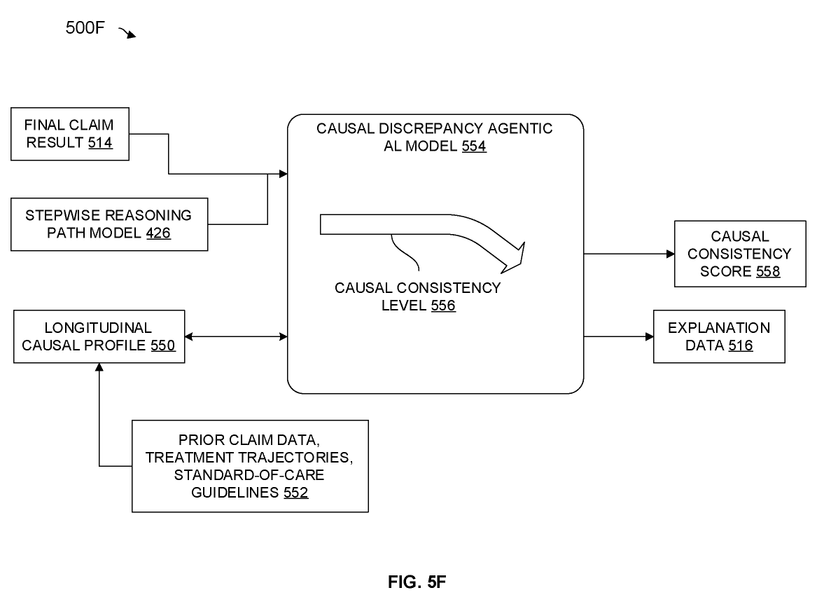

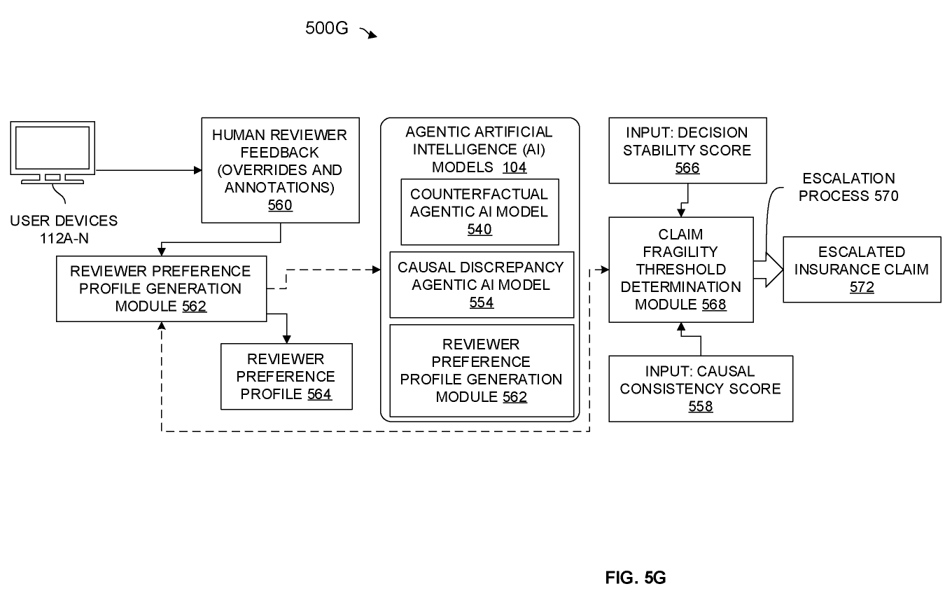

FIGS. 5A-5G illustrate exemplary schematic diagram representations depicting operational configurations of the computer-implemented system 102 for determining the final claim result 412 and the explanation data for the insurance claim, according to an embodiment of the present invention.

According to FIG. 5A, an exemplary schematic diagram representation depicting an operational configuration 500A of the computer-implemented system 102 for determining the final claim result 412 and the explanation data for the insurance claim, according to an embodiment of the present invention. The one or more insurance policy documents 420 may be processed by the data extraction agent 402 configured with a Natural Language Processing (NLP)-based model for performing semantic search and policy document embedding. The extracted representations may be provided to the policy evaluation agent 404 configured with a Large Language Model (LLM)-based rule extraction model to identify condition action pairs corresponding to one or more contextually relevant policy sections. The Generative Artificial Intelligence (Gen AI) model 126 may be configured to generate the sequence of dynamically determined evaluation instructions 316A-N and corresponding reasoning paths based on the extracted condition action pairs. The computer-implemented system 102 may further generate a sensitivity profile identifying the insurance-related data attributes 502 indicating attributes influencing claim outcomes, and construct a policy knowledge graph 504 representing relationships among policy clauses and claim attributes. The policy knowledge graph 504 may be stored in and/or obtained from the at least one policy database 308 to support policy interpretation and claim adjudication.

According to FIG. 5B, an exemplary schematic diagram representation depicting an operational configuration 500B of the computer-implemented system 102 for determining the final claim result 412 and the explanation data for the insurance claim, according to an embodiment of the present invention. The sequence of dynamically determined evaluation instructions 316A-N may be executed to generate the executed sequence of dynamically determined evaluation instructions 506 based on the extracted insurance-related data 508 and the one or more contextually relevant policy sections 510. The executed sequence of dynamically determined evaluation instructions 506, the extracted insurance-related data 508, and the one or more contextually relevant policy sections 510 may be provided to the reasoning agent 120 including the Gen AI model 122 configured to generate the stepwise reasoning path model 424 and a policy interpretation step output 512. The computer-implemented system 102 may determine the final claim result 412 based on the generated reasoning outputs. Further, the computer-implemented system 102 may generate the explanation data 516 corresponding to the final claim result 412. Furthermore, the explanation data 516 may include reasoning steps and references to the one or more insurance policy documents 420.

According to FIG. 5C, an exemplary schematic diagram representation depicting an operational configuration 500C of the computer-implemented system 102 for determining the final claim result 412 and the explanation data 516 for the insurance claim, according to an embodiment of the present invention. The multimodal external evidence data 518 may be obtained from the one or more external data sources. Further, the multimodal evidence data may be processed using a multimodal evidence cross-correlation agentic AI model 520 to generate the trust graph 522. The trust graph 522 may include the nodes 524 representing at least one of the activity level indicators 526A, the physical location patterns 526B, and the claim detail entities 526C. The nodes 524 may capture relationships between the insurance-related data 418 and external evidence. The trust graph 522 may be provided to the Bayesian anomaly agentic AI model 528 configured to compute the Bayesian claim anomaly score 530 representing a likelihood of anomalous behaviour associated with the insurance claim based on the relationships encoded in the trust graph 522.

According to FIG. 5D, an exemplary schematic diagram representation depicting an operational configuration 500D of the computer-implemented system 102 for determining the final claim result 412 and the explanation data 516 for the insurance claim, according to an embodiment of the present invention. The stepwise reasoning path model 424 may be provided to the reasoning agent 120 to generate a policy-driven final claim result 514 within a decision generating subsystem 532. The decision generating subsystem 532 may further receive the Bayesian claim anomaly score 530 computed using the Bayesian anomaly agentic AI model 528. Further, the decision generating subsystem 532 may apply the override decision junction logic 534 to evaluate whether the Bayesian claim anomaly score 530 may exceed a predefined anomaly threshold. The final claim result 412 may be selectively modified to generate the modified final claim result 536 based on the evaluation at the override decision junction logic 534. The modified final claim result 536 may include at least one of a policy-based denial and a Bayesian override approval derived from a trust graph-based evidence.

According to FIG. 5E, an exemplary schematic diagram representation depicting an operational configuration 500E of the computer-implemented system 102 for determining the final claim result 412 and the explanation data 516 for the insurance claim, according to an embodiment of the present invention. The final claim result 412, the structured claim attributes 538, and the one or more insurance policy documents 420 may be provided to the counterfactual agentic AI model 540. The counterfactual agentic AI model 540 may generate claim attribute variations 542. Further, the counterfactual agentic AI model 540 may execute the counterfactual instruction execution 544 to generate a plurality of counterfactual scenarios 546. Each of the plurality of counterfactual scenarios 546 may correspond to a modified version of the insurance claim. The plurality of counterfactual scenarios 546 may be processed by a decision stability computation module 548 to determine a stability measure of the final claim result 412. Further, the processor 106 may generate the explanation data 516 along with a sensitivity profile identifying the insurance-related data attributes 502. Further, the insurance-related data attributes 502 may influence variations in claim outcomes across the plurality of counterfactual scenarios 546.

According to FIG. 5F, an exemplary schematic diagram representation depicting an operational configuration 500F of the computer-implemented system 102 for determining the final claim result 412 and the explanation data 516 for the insurance claim, according to an embodiment of the present invention. The final claim result 412 and the stepwise reasoning path model 424 may be provided to the causal discrepancy agentic AI model 554 along with the longitudinal causal profile 550 derived from prior claim data, treatment trajectories, and standard-of-care guidelines 552. The causal discrepancy agentic AI model 554 may determine the causal consistency level 556. The causal consistency level 556 may represent an alignment between the final claim result 412, the stepwise reasoning path model 424, and the longitudinal causal profile 550. Further, the causal consistency level 556 may compute the causal consistency score 558 indicative of the degree of the alignment. Further, the processor 106 may generate the explanation data 516 based on the determined causal consistency level and the causal consistency score 558.

According to FIG. 5G, an exemplary schematic diagram representation depicting an operational configuration 500G of the computer-implemented system 102 for determining the final claim result 412 and the explanation data 516 for the insurance claim, according to an embodiment of the present invention. The one or more user devices 112A-N may provide the human reviewer feedback 560. The human reviewer feedback 560 may include overrides and annotation. Further, the overrides and annotation may be processed using a reviewer preference profile generation module 562 to generate a reviewer preference profile 564. The reviewer preference profile 564 may be applied to the plurality of agentic Artificial Intelligence (AI) models 104. The plurality of agentic AI models 104 may include, such as, for example, but not limited to, the counterfactual agentic AI model 540 and the causal discrepancy agentic AI model 554. Further, the plurality of agentic AI models 104 may be configured to refine evaluation outcomes. Further, a claim fragility threshold determination module 568 may receive as the inputs a decision stability score 566 and the causal consistency score 558. Furthermore, the claim fragility threshold determination module 568 may determine a claim fragility threshold value. In addition, the escalation process 570 may be triggered to generate the escalated insurance claim 572 for further review.

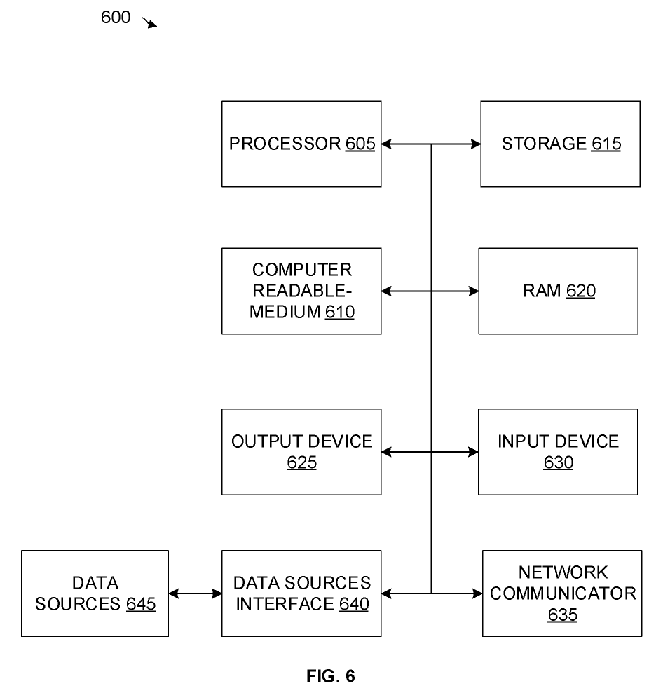

FIG. 6 illustrates an example block diagram representation of a hardware platform 600 for implementation of a computer system, in accordance with an embodiment of the present disclosure. The computer system may be part of or any one of the computer-implemented system 102, the plurality of agent systems 116A-N and the one or more user devices 112A-N, as shown in the network architecture 100, to perform the functions and features described herein.

Additionally, for the sake of brevity, construction, and operational features of the network architecture 100 which are explained in detail above are not explained in detail herein. Particularly, computing machines such as but not limited to internal/external server clusters, quantum computers, desktops, laptops, smartphones, tablets, and wearables which may be used to execute the network architecture 100 and/or may have the structure of the hardware platform 600. As illustrated, the hardware platform 600 may include additional components not shown, and that some of the components described may be removed and/or modified. For example, the computer system with multiple graphics processing unit (GPUs) may be located on external cloud platforms including web services, and/or internal corporate cloud computing clusters, or organizational computing resources, and the like.

Additionally, the hardware platform 600 may be the computer system such as the network architecture 100 that may be used with the embodiments described herein. The computer system may represent a computational platform that includes components that may be in a server or another computer system. The computer system may execute, by a processor 605, for example, a single and/or multiple processors, or other hardware processing circuit, the methods, functions, and other processes described herein. These methods, functions, and other processes may be embodied as machine readable instructions stored on a computer readable medium, which may be non-transitory, such as hardware storage devices, for example, RAM (random access memory), ROM (read only memory), EPROM (erasable, programmable ROM), EEPROM (electrically erasable, programmable ROM), hard drives, and flash memory. The computer system may include the processor 605 that executes software instructions or code stored on a computer readable storage medium 610 to perform methods of the present disclosure.

Additionally, the instructions on the computer readable storage medium 610 are read and stored the instructions in a storage 615 and/or in random access memory (RAM). The storage 615 may provide a space for keeping static data where at least some instructions could be stored for later execution. The stored instructions may be further compiled to generate other representations of the instructions and dynamically stored in the RAM such as RAM 620. The processor 605 may read instructions from the RAM 620 and perform actions as instructed.

Additionally, the computer system may further include an output device 525 to provide at least some of the results of the execution as output including, but not limited to, visual information to users, such as external agents. Further, an output device 625 may include a display on computing devices. For example, the display may be a mobile phone screen or a laptop screen. Graphical user interfaces (GUIs) and/or text may be presented as an output on the display screen. The computer system may further include an input device 630 to provide a user or another device with mechanisms for entering data and/or otherwise interact with the computer system. The input device 630 may include, for example, a keyboard, a keypad, a mouse, or a touchscreen. Each of the output device 625 and the input device 630 may be joined by additional peripherals. For example, the output device 625 may be used to display the results.

Additionally, a network communicator 635 may be provided to connect the computer-implemented system 102 to the network 110 and in turn to other devices connected to the network including other clients, servers, data stores, and interfaces, for instance. Further, the network communicator 635 may include, for example, a network adapter such as a LAN adapter or a wireless adapter. The computer system may include a data sources interface 640 to access data sources 645. The data sources 645 may be an information resource. As an example, a database of exceptions and rules may be provided as the data sources 645. Moreover, knowledge repositories and curated data may be other examples of the data source 645.

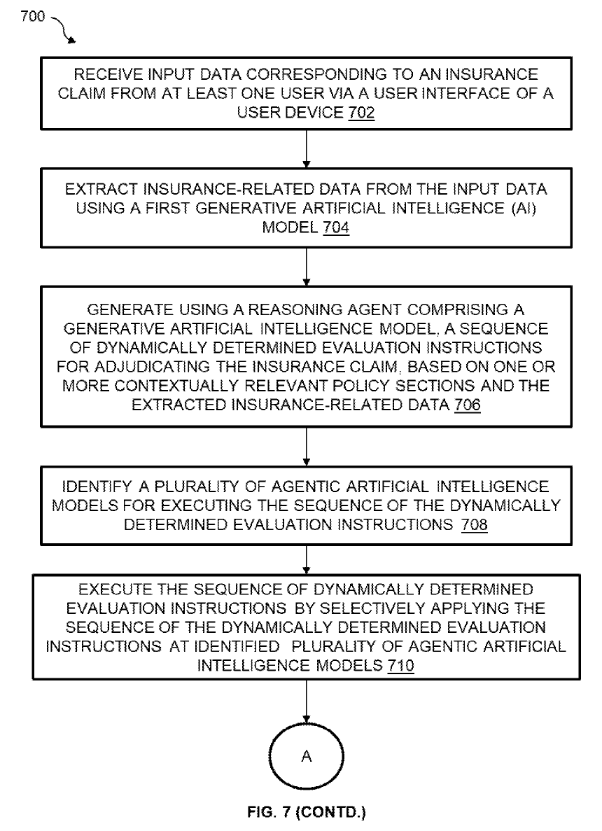

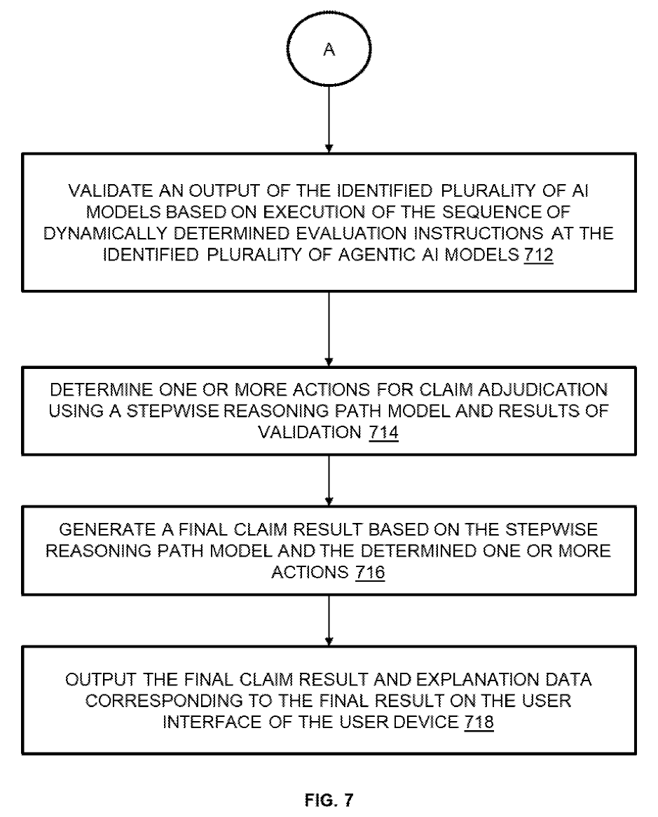

FIG. 7 illustrates an example flow diagram representation of a method 700 for processing insurance claims using the plurality of agentic artificial intelligence models 104, according to an example.

At block 702, the method 700 may include receiving, by the processor 106, input data 304 corresponding to the insurance claim from at least one user via the user interface 302 of the user device 112. The input data 304 may include at least one of claim data 306, claimant attributes, the provider information 422, and the one or more insurance policy documents 420.

At block 704, the method 700 may include extracting, by the processor 106, the insurance-related data 418 from the input data 304 using the first generative Artificial Intelligence (AI) model. The extracted insurance-related data 508 may include at least one of the structured claim attributes 538 and the unstructured claim attributes 318. The extracted insurance-related data 508 may include at least one of diagnosis codes, procedure codes, treatment descriptions, and contextual claim attributes.

At block 706, the method 700 may include generating, by the processor 106, using the reasoning agent 120. The reasoning agent 120 may include the artificial intelligence model, the sequence of dynamically determined evaluation instructions 316A-N for adjudicating the insurance claim, based on the one or more contextually relevant policy sections 510 and the extracted insurance-related data 508. Each of the dynamically determined evaluation instructions may correspond to a policy interpretation step obtained from the one or more contextually relevant policy sections 510 of the one or more insurance policy documents 420.

At block 708, the method 700 may include identifying, by the processor 106, the plurality of agentic artificial intelligence models for executing the sequence of the dynamically determined evaluation instructions. The plurality of agentic artificial intelligence models may include at least one of the data extraction agent 402, the policy evaluation agent 404, and the reasoning agent 120.

At block 710, the method 700 may include executing, by the processor 106, the sequence of dynamically determined evaluation instructions 316A-N by selectively applying the sequence of the dynamically determined evaluation instructions at identified plurality of agentic artificial intelligence models.

At block 712, the method 700 may include validating, by the processor 106, an output of the identified plurality of AI models based on execution of the sequence of the dynamically determined evaluation instructions at the identified plurality of agentic AI models.

At block 714, the method 700 may include determining, by the processor 106, one or more actions for claim adjudication using the stepwise reasoning path model 424 and results of validation. The one or more actions may include retrieving additional claim data 406, generating external application programming interfaces, and refining the policy evaluation 410.

At block 716, the method 700 may include generating, by the processor 106, the final claim result 412 based on the stepwise reasoning path model 424 and the determined one or more actions.

At block 718, the method 700 may include outputting, by the processor 106, the final claim result 412 and the explanation data 516 corresponding to the final result on the user interface 302 of the user device 112. The explanation data 516 may include at least one of references to the one or more insurance policy documents 420 and the stepwise reasoning path model 424.

In an example, the method 700 may include generating, by the processor 106, the plurality of counterfactual scenarios 546, upon generating the sequence of dynamically determined evaluation instructions 316A-N, by perturbing at least one of the claim attributes within the structured claim attributes 538, the extracted insurance-related data 508, parameters of the one or more insurance policy documents 420 and alternative interpretations of the unstructured claim attributes. Further, the method 700 may include executing, by the processor 106, the sequence of dynamically determined evaluation instructions 316A-N on each of the plurality of counterfactual scenarios 546 using the counterfactual agentic AI model 540 including the Gen AI model 122. The counterfactual agentic AI model 540 may generate counterfactual stepwise reasoning paths corresponding to each counterfactual scenario. Furthermore, the method 700 may include computing, by the processor 106, a decision stability score representing a proportion of the plurality of counterfactual scenarios 546 to generate a claim result distinct from the final claim result 412. In addition, the method 700 may include generating, by the processor 106, the explanation data 516 for the decision stability score. The explanation data 516 may include a sensitivity profile identifying the insurance-related data attributes 502 frequently altering the final claim result 412 across the plurality of counterfactual scenarios 546.

In another example, the method 700 may include retrieving, by the processor 106, the longitudinal causal profile 550 for a claimant from the at least one policy database 308. The longitudinal causal profile 550 may include prior claim data, treatment trajectories, and standard-of-care guidelines 552 obtained from the one or more insurance policy documents 420. The method 700 may include evaluating, by the processor 106, the causal consistency level 556 between the final claim result 412, the stepwise reasoning path, and the longitudinal causal profile 550 using the causal discrepancy agentic AI model 554 including the Gen AI model 122. Further, the method 700 may include computing, by the processor 106, the causal consistency scores 558 representing an alignment between the final claim result 412 and expected causal trajectories implied by the longitudinal causal profile 550 and policy guidelines.

In another example, to evaluate the causal consistency level 556 between the final claim result 412, the stepwise reasoning path, and the longitudinal causal profile 550 using the causal discrepancy agentic AI model 554, the method 700 may include determining, by the processor 106, whether the final claim result 412 and dynamically determined evaluation instructions may be causally consistent with at least one of a historical treatment results of the claimant, normative recovery timelines encoded in the one or more insurance policy documents 420, and prerequisite procedure requirements from prior claims.

In another example, the method 700 may include receiving, by the processor 106, via the user interface 302, the human reviewer feedback 560 on previously adjudicated claims. The human reviewer feedback 560 may include overrides of final claim results and annotations to specific policy sections. The method 700 may include generating, by the processor 106, the reviewer preference profile 564 for the at least one user based on the human reviewer feedback 560. The reviewer preference profile 564 may include one or more distributions over policy interpretation preferences and rationale generation patterns aligned with the one or more insurance policy documents 420. The reviewer preference profile 564 may be generated by filtering the human reviewer feedback 560 to extract one or more reviewer behaviors consistent with policy guidelines in the one or more insurance policy documents 420, and encoding the filtered one or more reviewer behaviors as preference vectors applied to prompts of the reasoning agent 120. Further, the method 700 may include generating, by the processor 106, one or more conditions for the stepwise reasoning path and the explanation data 516 based on the reviewer preference profile 564 associated with the at least one user. Furthermore, the method 700 may include embedding, by the processor 106, an alignment delta indicator in the explanation data 516. The alignment delta indicator may represent modifications to the stepwise reasoning path based on the reviewer preference profile 564.

In another example, the method 700 may include determining, by the processor 106, a fragility threshold value for the insurance claim based on a decision stability score and the causal consistency score 558. The method 700 may include triggering, by the processor 106, the escalation process 570 for the insurance claim for external review via the user interface 302 if the fragility threshold value is exceeded. Further, the method 700 may include embedding, by the processor 106, the explanation data 516 augmented with the plurality of counterfactual scenarios 546, causal discrepancies, and reviewer preference alignments to the escalated insurance claim 572.

In another example, to validate the output of the executed sequence of dynamically determined evaluation instructions 506, the method 700 may further include cross-validating, by the processor 106, the outputs from the plurality of agentic AI models 104 with the plurality of counterfactual scenarios 546 and the longitudinal causal profile 550.

In another example, the method 700 may include receiving, by the processor 106, the multimodal external evidence data 518 from the one or more external data sources. The multimodal external evidence data 518 may include at least one of social media activity data, geolocation data, public records data, and biometric log data associated with the claimant. Further, the method 700 may include generating, by the processor 106, the trust graph 522 representing behavioral relationships and physical relationships between the insurance-related data 418 and the multimodal external evidence data 518 using the multimodal evidence cross-correlation agentic AI model 520. The trust graph 522 may include the nodes 524 representing at least one of the activity level indicators 526A, the physical location patterns 526B, the claim detail entities 526C, and cross-domain evidence entities obtained from the multimodal external evidence data 518. Furthermore, the method 700 may include computing, by the processor 106, the Bayesian claim anomaly score 530 representing a posterior probability of anomalous behavior indicated in the trust graph 522 and a stepwise reasoning path generated by the reasoning agent 120 using the Bayesian anomaly agentic AI model 528.

In another example, to generate the trust graph 522 representing the behavioral relationships and the physical relationships between the insurance-related data 418 and the multimodal external evidence data 518, the method 700 may include correlating, by the processor 106, temporal patterns and spatial patterns in the multimodal external evidence data 518 with timestamps and locations encoded in the extracted insurance-related data 508. Further, the method 700 may include establishing, by the processor 106, directed edges in the trust graph 522 between claim detail nodes and external evidence nodes based on at least one of a co-occurrence in time, a spatial proximity, and a behavioral inconsistency level with expected claimant profiles implied by the one or more insurance policy documents 420.

In another example, to compute the Bayesian claim anomaly score 530, the method 700 may include determining, by the processor 106, a deviation between policy-driven conclusions in the stepwise reasoning path and behavioral patterns encoded in the trust graph 522. The method 700 may include determining, by the processor 106, if the Bayesian claim anomaly score 530 may exceed a predefined anomaly threshold value. Further, the method 700 may include applying, by the processor 106, the Bayesian claim anomaly score 530 at a decision junction to override the final claim result 412 generated based on the stepwise reasoning path and based on the determined deviation, if the Bayesian claim anomaly score 530 may exceed a predefined anomaly threshold value. The override may generate the modified final claim result 536. The modified final claim result 536 may include at least one of a denial, a flag for manual review, and an escalated approval requirement. Further, the method 700 may include generating, by the processor 106, override rationale data. The override rationale data may include an original stepwise reasoning path and a justification data for the Bayesian claim anomaly score 530.

In another example, the explanation data 516 for overridden claims may include a multi-panel visualization. The multi-panel visualization may include a primary stepwise reasoning path, a graphical representation of the trust graph 522, the Bayesian claim anomaly score 530, and the override decision junction logic 534.

In another example, to extract the insurance‑related data from the input data 304 using the first Generative Artificial Intelligence (Gen AI) model 118, the method 700 may include generating, by the processor 106, one or more tokens corresponding to textual portions of the input data 304 using the first Gen AI model 118. The textual portions may include at least one of free‑text treatment descriptions, provider notes, and claimant notes. Further, the method 700 may include identifying, by the processor 106, entities corresponding to at least one of diagnoses, procedures, body parts, medications, and dates by determining at least one a named‑entity data in the generated one or more tokens. Furthermore, the method 700 may include mapping, by the processor 106, the identified entities to standardized diagnosis codes and procedure codes using one or more medical coding ontologies and based on the first Gen AI model 118. In addition, the method 700 may include parsing, by the processor 106, structured fields of the claim data 306, the claimant attributes, and the provider information 422 to obtain the structured claim attributes 538 using the first Gen AI model 118. The structured claim attributes 538 may include at least one of normalized codes, normalized amounts, and normalized dates. Further, the method 700 may include determining, by the processor 106, the unstructured claim attributes using the first Gen AI model 118. The unstructured claim attributes may include at least one of an inferred severity, an inferred place of service, an inferred claim context, and narrative treatment descriptions from the textual portions. Furthermore, the method 700 may include outputting, by the processor 106, the structured claim attributes 538 and the unstructured claim attributes as the extracted insurance‑related data in an insurance‑related data object.

In another example, to generate the sequence of dynamically determined evaluation instructions 316A-N for adjudicating the insurance claim using the reasoning agent 120, the method 700 may include generating, by the processor 106, a contextual query from at least a subset of the extracted insurance‑related data using the reasoning agent 120. The contextual query may include the diagnosis codes, procedure codes, and contextual claim attributes. Further, the method 700 may include retrieving, by the processor 106, the one or more contextually relevant policy sections 510 from the at least one policy database 308 by applying the contextual query to the one or more insurance policy documents 420 using the reasoning agent 120. Furthermore, the method 700 may include segmenting, by the processor 106, the retrieved one or more contextually relevant policy sections into a plurality of policy clauses using the reasoning agent 120. Each policy clause may correspond to at least one of a coverage condition, an exclusion, a limitation, and a medical necessity requirement. In addition, the method 700 may include determining, by the processor 106, a subsequent evaluation operation by applying a stepwise chain‑of‑thought reasoning process over the extracted insurance‑related data and the plurality of policy clauses using the reasoning agent 120. Further, the method 700 may include generating, by the processor 106, an evaluation instruction corresponding to the determined subsequent evaluation operation. The evaluation instruction may include at least one of a policy clause identifier, a required input parameter, and an expected output parameter. Furthermore, the method 700 may include appending, by the processor 106, the generated evaluation instruction to the sequence of dynamically determined evaluation instructions 316A-N. In addition, the method 700 may include iteratively repeating, by the processor 106, the process of determining, generating, and appending until the policy interpretation steps required by the retrieved contextually relevant policy sections may be covered.

In another example, to identify the plurality of agentic Artificial Intelligence (AI) models 104 for executing the sequence of the dynamically determined evaluation instructions, the method 700 may include obtaining, by the processor 106, metadata corresponding to the plurality of agentic Artificial Intelligence (AI) models 104 from a database. The metadata may include capabilities of each of the plurality of agentic AI models 104. The capabilities may include at least one of input types, output types, and associated policy evaluation functions. Further, the method 700 may include identifying, by the processor 106, an operation type and one or more required inputs by parsing each evaluation instruction in the sequence of dynamically determined evaluation instructions 316A-N using the reasoning agent 120. Furthermore, the method 700 may include selecting, by the processor 106, at least one agentic AI model for each parsed evaluation instruction based on the capabilities of agentic AI model satisfying the identified operation type and the one or more required inputs. In addition, the method 700 may include mapping, by the processor 106, each evaluation instruction to the selected at least one agentic AI model. The selected agentic AI model may include at least one of the data extraction agent 402, the policy evaluation agent 404, and the reasoning agent 120.

In another example, to execute the sequence of the dynamically determined evaluation instructions by selectively applying the sequence at the identified plurality of agentic AI models, the method 700 may include executing, by the processor 106, the identified agentic AI model with input parameters for each evaluation instruction. The input parameters may include at least a portion of the extracted insurance‑related data and intermediate results from previously executed evaluation instructions. Further, the method 700 may include receiving, by the processor 106, an evaluation result as an output from the agentic AI model. The evaluation result may include at least one of a Boolean decision, a numerical value, a classification label, and an extracted data field. Furthermore, the method 700 may include updating, by the processor 106, a claim evaluation state database with the received evaluation result in association with the evaluation instruction. In addition, the method 700 may include outputting, by the processor 106, the updated claim evaluation state database as a context to a subsequent evaluation instruction in the sequence.

In addition, to validate the output of the identified plurality of agentic AI models based on the executed sequence of the dynamically determined evaluation instructions, the method 700 may include aggregating, by the processor 106, evaluation results generated by each of the plurality of agentic AI models 104 into a consolidated result set. Further, the method 700 may include determining, by the processor 106, whether the evaluation results for each evaluation instruction satisfies one or more predefined consistency checks. The one or more predefined consistency checks may include at least one of range checks, type checks, and logical dependency checks. Furthermore, the method 700 may include detecting, by the processor 106, conflicts between the evaluation results corresponding to a plurality of evaluation instructions and prestored result corresponding to one of a similar policy clause and a similar claim attribute. In addition, the method 700 may include assigning, by the processor 106, a confidence score to each evaluation result based on at least one of a source agentic AI model type, a historical performance metric, and the detected conflicts. Further, the method 700 may include generating, by the processor 106, a validation result object indicating at least one of validated evaluation results, flagged evaluation results, and associated confidence scores.

In addition, to determine the one or more actions for the claim adjudication using the stepwise reasoning path model 424 and the results of validation, the method 700 may include generating, by the processor 106, the stepwise reasoning path model 424 representing the nodes 524 corresponding to the evaluation instructions and edges corresponding to dependencies between the evaluation results. Further, the method 700 may include annotating, by the processor 106, the nodes 524 of the stepwise reasoning path model 424 with a validation result object. The validation result object may include validated evaluation results and flagged evaluation results. Furthermore, the method 700 may include identifying, by the processor 106, points in a stepwise reasoning path requiring information by traversing the stepwise reasoning path model 424 based on a predefined traversal strategy. In addition, the method 700 may include determining, by the processor 106, the one or more actions for the claim adjudication at each of the identified points. The one or more actions may include at least one of retrieving additional claim data 406, generating the one or more external application programming interfaces (APIs) 408, and refining the policy evaluation 410 by regenerating and adjusting one or more evaluation instructions. Further, the method 700 may include generating, by the processor 106, an action plan for each determined action. The action plan may include an associated target data source, external API endpoint, and a condition for executing the action.

In another example, to generate the final claim result 412 based on the stepwise reasoning path model 424 and the determined one or more actions, the method 700 may include executing, by the processor 106, an action plan by performing the retrieval of additional claim data 406, generating the external APIs 408, and refining the policy evaluation 410 until the stepwise reasoning path model 424 may indicate completion of required actions. Further, the method 700 may include updating, by the processor 106, the stepwise reasoning path model 424 to reflect results of the executed actions. Furthermore, the method 700 may include determining, by the processor 106, a claim disposition result. The claim disposition result may include at least one of an approval, a denial, and a pending status based on a terminal state of the updated stepwise reasoning path model. In addition, the method 700 may include calculating, by the processor 106, a payable amount based on covered services, applicable deductibles, copayments, and coinsurance as indicated by the evaluation results represented in the stepwise reasoning path model 424. Further, the method 700 may include generating, by the processor 106, the final claim result 412. The final claim result 412 may include at least one of the claim disposition result and the calculated payable amount.

In another example, to output the final claim result 412 and the explanation data 516 corresponding to the final result on the user interface 302 of the user device 112, the method 700 may include generating, by the processor 106, a structured explanation object by mapping a relevant subset of the nodes 524 and edges of the stepwise reasoning path model 424 with the final claim result 412 and map identifiers of the one or more insurance policy documents 420 and the corresponding policy sections with each of the subset of the nodes 524. Further, the method 700 may include generating, by the processor 106, a natural language explanation segment for each of the subset of the nodes 524. The natural language explanation segment may include a description of a corresponding policy interpretation step and corresponding result. Furthermore, the method 700 may include embedding, by the processor 106, the natural language explanation segment into the explanation data 516 along with references to the one or more insurance policy documents 420 and the stepwise reasoning path model 424.

The order in which the method 700 may be described may not be intended to be construed as a limitation, and any number of the described method blocks may be combined or otherwise performed in any order to implement the method 700 or an alternate method. Additionally, individual blocks may be deleted from the method 700 without departing from the spirit and scope of the ongoing description. Furthermore, the method 700 may be implemented in any suitable hardware, software, firmware, or a combination thereof, that exists in the related art and/or that is later developed. The method 700 describes, without limitation, the implementation of the computer-implemented system 102. A person of skill in the art will understand that method 700 may be modified appropriately for implementation in various manners without departing from the scope and spirit of the ongoing description.

Various examples herein provide a system 102 and method 700 for processing insurance claims using the plurality of agentic Artificial Intelligence (AI) models 104. The present disclosure may reduce a manual workload by accelerating a claim adjudication process. Further, the present disclosure may enhance consistency and accuracy by strictly adhering to the insurance policies. Furthermore, the present disclosure may provide transparency in decision-making by showcasing one or more policy references. In addition, the present disclosure may adapt to new guidelines and policies quickly through a Large Language Model (LLM) retraining. Further, the present disclosure may be applied in a healthcare industry. In the healthcare industry, a health insurance claim for a knee replacement surgery may be submitted. Furthermore, the present disclosure may provide an Artificial Intelligence (AI) agent may extract one or more relevant details from the health insurance claim. In addition, the AI agent may retrieve one or more corresponding policy guidelines associated with one or more knee replacement procedures. Further, the AI agent may determine compliance of the health insurance claim with the retrieved one or more corresponding policy guidelines. The present disclosure may provide the reasoning agent 120. The reasoning agent 120 may adjudicate the health insurance claim by approving, denying, and/or placing the health insurance claim in a pending state for further review based on the one or more corresponding policy guidelines. Further, the reasoning agent 120 may provide a clear rationale along with references to one or more sections of one or more insurance policy documents 420. The present disclosure may be applied in a financial services industry. In the financial services industry, a customer may file a claim and/or request an explanation of an approval process, including, such as, for example, but not limited to, a loan, a credit card, or an appeal. Further, in the financial services industry, the reasoning agent 120 may validate a provided information in conjunction with one or more applicable policies required for adjudication. The reasoning agent 120 may determine eligibility of a financial product and/or an associated claim amount.

In an example, the present disclosure may be applied to healthcare administration. Further, the present disclosure may process the insurance claims using the plurality of agentic Artificial Intelligence (AI) models 104. The present disclosure may utilize one or more advanced Natural Language Processing (NLP) techniques implemented through one or more Generative Artificial Intelligence (Gen AI) models to process the input data 304 corresponding to the insurance claim, interpret the one or more insurance policy documents 420, and generate the final claim result 412 and the explanation data 516. The present disclosure may particularly provide an automated adjudication of the insurance claims by extracting the insurance-related data 418. Further, the present disclosure may generate the sequence of dynamically determined evaluation instructions 316A-N. Furthermore, the present invention may apply the policy interpretation steps derived from the one or more insurance policy documents 420.

One of ordinary skill in the art will appreciate that techniques consistent with the ongoing description are applicable in other contexts as well without departing from the scope of the ongoing description.

As mentioned above, what is shown and described with respect to the systems and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing handoff.

It should also be appreciated that the systems and methods, as described herein, may also include, or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine readable instructions. The software or firmware may include subroutines or applications that perform the functions of the measurement system and/or run one or more application that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include the network 110 and/or communication interface to communicate with other servers, devices, components, or network elements via a network or other communication protocol.

What has been described and illustrated herein are examples of the implementation along with some variations. The terms, descriptions, and figures used herein are set forth by way of illustration only and are not meant as limitations. Many variations are possible within the scope of the implementations, which is intended to be defined by the following claims and their equivalents in which all terms are meant in their broadest reasonable sense unless otherwise indicated.

1. A computer-implemented system for determining outcomes of insurance claims using a plurality of agentic Artificial Intelligence (AI) models, wherein the computer-implemented system comprises:
a processor; and
a memory communicatively coupled to the processor, wherein the memory comprises processor-executable instructions which, when executed by the processor, cause the processor to:
receive input data corresponding to an insurance claim from at least one user via a user interface of a user device, wherein the input data comprises at least one of claim data, claimant attributes, provider information, and one or more insurance policy documents;
extract insurance-related data from the input data using a first Generative Artificial Intelligence (Gen AI) model, wherein the extracted insurance-related data comprises at least one of structured claim attributes and unstructured claim attributes, and wherein the extracted insurance-related data comprises at least one of diagnosis codes, procedure codes, treatment descriptions, and contextual claim attributes;
generate, using a reasoning agent comprising a Gen AI model, a sequence of dynamically determined evaluation instructions for adjudicating the insurance claim, based on one or more contextually relevant policy sections and the extracted insurance-related data, wherein each of the dynamically determined evaluation instructions correspond to a policy interpretation step obtained from the one or more contextually relevant policy sections of the one or more insurance policy documents;
identify a plurality of agentic Artificial Intelligence (AI) models for executing the sequence of the dynamically determined evaluation instructions, wherein the plurality of agentic AI models comprise at least of a data extraction agent, a policy evaluation agent, and the reasoning agent;
execute the sequence of dynamically determined evaluation instructions by selectively applying the sequence of the dynamically determined evaluation instructions at the identified plurality of agentic AI models;
validate an output of the identified plurality of AI models based on execution of the sequence of the dynamically determined evaluation instructions at the identified plurality of agentic AI models;
determine one or more actions for claim adjudication using a stepwise reasoning path model and results of validation, wherein the one or more actions comprise retrieving additional claim data, generating external application programming interfaces (APIs), and refining a policy evaluation;
generate a final claim result based on the stepwise reasoning path model and the determined one or more actions; and
output the final claim result and an explanation data corresponding to the final result on the user interface of the user device, wherein the explanation data comprises at least one of references to the one or more insurance policy documents and the stepwise reasoning path model.

2. The computer-implemented system of claim 1, wherein the processor is further configured to:
retrieve a longitudinal causal profile for a claimant from the at least one policy database, wherein the longitudinal causal profile comprises prior claim data, treatment trajectories, and standard-of-care guidelines obtained from the one or more insurance policy documents;
evaluate a causal consistency level between the final claim result, the stepwise reasoning path, and the longitudinal causal profile using a causal discrepancy agentic AI model comprising a Gen AI model; and
compute a causal consistency score representing an alignment between the final claim result and expected causal trajectories implied by the longitudinal causal profile and policy guidelines.

3. The computer-implemented system of claim 1, wherein the processor is further configured to:
receive multimodal external evidence data from one or more external data sources, wherein the multimodal external evidence data comprises at least one of social media activity data, geolocation data, public records data, and biometric log data associated with the claimant;
generate a trust graph representing behavioral relationships and physical relationships between the insurance-related data and the multimodal external evidence data using a multimodal evidence cross-correlation agentic AI model, wherein the trust graph comprises nodes representing at least one of activity level indicators, physical location patterns, claim detail entities, and cross-domain evidence entities obtained from the multimodal external evidence data; and
compute a Bayesian claim anomaly score representing a posterior probability of anomalous behavior indicated in the trust graph and a stepwise reasoning path generated by the reasoning agent using a Bayesian anomaly agentic AI model.

4. The computer-implemented system of claim 3, wherein to compute the Bayesian claim anomaly score, the processor is configured to:
determine a deviation between policy-driven conclusions in the stepwise reasoning path and behavioral patterns encoded in the trust graph;
determine if the Bayesian claim anomaly score exceeds a predefined anomaly threshold value;
apply the Bayesian claim anomaly score at a decision junction to override the final claim result generated based on the stepwise reasoning path and based on the determined deviation, if the Bayesian claim anomaly score exceeds a predefined anomaly threshold value, wherein the override generates a modified final claim result comprising at least one of a denial, a flag for manual review, and an escalated approval requirement; and
generate override rationale data comprising an original stepwise reasoning path and a justification data for the Bayesian claim anomaly score.

5. The computer‑implemented system of claim 1, wherein to extract the insurance‑related data from the input data using the first Generative Artificial Intelligence (Gen AI) model, the processor is configured to:
generate one or more tokens corresponding to textual portions of the input data using the first Gen AI model, wherein the textual portions comprise at least one of free‑text treatment descriptions, provider notes, and claimant notes;
identify entities corresponding to at least one of diagnoses, procedures, body parts, medications, and dates by determining at least one a named‑entity data in the generated one or more tokens;
map the identified entities to standardized diagnosis codes and procedure codes using one or more medical coding ontologies and based on the first Gen AI model;
parse structured fields of the claim data, the claimant attributes, and provider information to obtain the structured claim attributes using the first Gen AI model, wherein the structured claim attributes comprise at least one of normalized codes, normalized amounts, and normalized dates;
determine the unstructured claim attributes using the first Gen AI model, wherein the unstructured claim attributes comprise at least one of an inferred severity, an inferred place of service, an inferred claim context, and narrative treatment descriptions from the textual portions; and
output the structured claim attributes and the unstructured claim attributes as the extracted insurance‑related data in an insurance‑related data object.

6. The computer‑implemented system of claim 1, wherein to generate the sequence of dynamically determined evaluation instructions for adjudicating the insurance claim using the reasoning agent, the processor is configured to:
generate a contextual query from at least a subset of the extracted insurance‑related data using the reasoning agent, wherein the contextual query comprises the diagnosis codes, procedure codes, and contextual claim attributes;
retrieve the one or more contextually relevant policy sections from the at least one policy database by applying the contextual query to the one or more insurance policy documents using the reasoning agent;
segment the retrieved one or more contextually relevant policy sections into a plurality of policy clauses using the reasoning agent, wherein each policy clause corresponds to at least one of a coverage condition, an exclusion, a limitation, and a medical necessity requirement;
determine a subsequent evaluation operation by applying a stepwise chain‑of‑thought reasoning process over the extracted insurance‑related data and the plurality of policy clauses using the reasoning agent;
generate an evaluation instruction corresponding to the determined subsequent evaluation operation, wherein the evaluation instruction comprises at least one of a policy clause identifier, a required input parameter, and an expected output parameter;
append the generated evaluation instruction to the sequence of dynamically determined evaluation instructions; and
iteratively repeat the process of determining, generating, and appending until the policy interpretation steps required by the retrieved contextually relevant policy sections is being covered.

7. The computer‑implemented system of claim 1, wherein to identify the plurality of agentic Artificial Intelligence (AI) models for executing the sequence of the dynamically determined evaluation instructions, the processor is configured to:
obtain metadata corresponding to the plurality of agentic Artificial Intelligence (AI) models from a database, wherein the metadata comprises capabilities of each of the plurality of agentic AI models, and wherein the capabilities comprise at least one of input types, output types, and associated policy evaluation functions;
identify an operation type and one or more required inputs by parsing each evaluation instruction in the sequence of dynamically determined evaluation instructions using the reasoning agent;
select at least one agentic AI model for each parsed evaluation instruction based on the capabilities of agentic AI model satisfying the identified operation type and the one or more required inputs; and
map each evaluation instruction to the selected at least one agentic AI model, wherein the selected agentic AI model comprise at least one of the data extraction agent, the policy evaluation agent, and the reasoning agent.

8. The computer‑implemented system of claim 1, wherein to execute the sequence of the dynamically determined evaluation instructions by selectively applying the sequence at the identified plurality of agentic AI models, the processor is configured to:
execute the identified agentic AI model with input parameters for each evaluation instruction, wherein the input parameters comprise at least a portion of the extracted insurance‑related data and intermediate results from previously executed evaluation instructions;
receive an evaluation result as an output from the agentic AI model, wherein the evaluation result comprises at least one of a Boolean decision, a numerical value, a classification label, and an extracted data field;
update a claim evaluation state database with the received evaluation result in association with the evaluation instruction; and
output the updated claim evaluation state database as a context to a subsequent evaluation instruction in the sequence.

9. The computer‑implemented system of claim 1, wherein to validate the output of the identified plurality of agentic AI models based on the executed sequence of the dynamically determined evaluation instructions, the processor is configured to:
aggregate evaluation results generated by each of the plurality of agentic AI models into a consolidated result set;
determine whether the evaluation results for each evaluation instruction satisfies one or more predefined consistency checks, wherein the one or more predefined consistency checks comprise at least one of range checks, type checks, and logical dependency checks;
detect conflicts between the evaluation results corresponding to a plurality of evaluation instructions and prestored result corresponding to one of a similar policy clause and a similar claim attribute;
assign a confidence score to each evaluation result based on at least one of a source agentic AI model type, a historical performance metric, and the detected conflicts; and
generate a validation result object indicating at least one of validated evaluation results, flagged evaluation results, and associated confidence scores.

10. The computer‑implemented system of claim 1, wherein to determine the one or more actions for the claim adjudication using the stepwise reasoning path model and the results of validation, the processor is configured to:
generate the stepwise reasoning path model representing nodes corresponding to the evaluation instructions and edges corresponding to dependencies between the evaluation results;
annotate the nodes of the stepwise reasoning path model with a validation result object, wherein the validation result object comprises validated evaluation results and flagged evaluation results;
identify points in a stepwise reasoning path requiring information by traversing the stepwise reasoning path model based on a predefined traversal strategy;
determine the one or more actions for the claim adjudication at each of the identified points, wherein the one or more actions comprise at least one of retrieving additional claim data, generating external application programming interfaces (APIs), and refining a policy evaluation by regenerating and adjusting one or more evaluation instructions; and
generate an action plan for each determined action, wherein the action plan comprises an associated target data source, external API endpoint, and a condition for executing the action.

11. The computer‑implemented system of claim 1, wherein to generate the final claim result based on the stepwise reasoning path model and the determined one or more actions, the processor is configured to:
execute an action plan by performing the retrieval of additional claim data, generating the external APIs, and refining the policy evaluation until the stepwise reasoning path model indicates completion of required actions;
update the stepwise reasoning path model to reflect results of the executed actions;
determine a claim disposition result comprising at least one of an approval, a denial, and a pending status based on a terminal state of the updated stepwise reasoning path model;
calculate a payable amount based on covered services, applicable deductibles, copayments, and coinsurance as indicated by the evaluation results represented in the stepwise reasoning path model; and
generate the final claim result comprising at least one of the claim disposition result and the calculated payable amount.

12. A method for determining outcomes of insurance claims using a plurality of agentic Artificial Intelligence (AI) models, the method comprising:
receiving, by a processor, input data corresponding to an insurance claim from at least one user via a user interface of a user device, wherein the input data comprises at least one of claim data, claimant attributes, provider information, and one or more insurance policy documents;
extracting, by the processor, insurance-related data from the input data using a first generative Artificial Intelligence (AI) model, wherein the extracted insurance-related data comprises at least one of structured claim attributes and unstructured claim attributes, and wherein the extracted insurance-related data comprises at least one of diagnosis codes, procedure codes, treatment descriptions, and contextual claim attributes;
generating, by the processor, using a reasoning agent comprising a generative artificial intelligence model, a sequence of dynamically determined evaluation instructions for adjudicating the insurance claim, based on one or more contextually relevant policy sections and the extracted insurance-related data, wherein each of the dynamically determined evaluation instructions correspond to a policy interpretation step obtained from the one or more contextually relevant policy sections of the one or more insurance policy documents;
identifying, by the processor, a plurality of agentic artificial intelligence models for executing the sequence of the dynamically determined evaluation instructions, wherein the plurality of agentic artificial intelligence models comprise at least one of a data extraction agent, a policy evaluation agent, and the reasoning agent;
executing, by the processor, the sequence of dynamically determined evaluation instructions by selectively applying the sequence of the dynamically determined evaluation instructions at identified plurality of agentic artificial intelligence models;
validating, by the processor, an output of the identified plurality of AI models based on execution of the sequence of the dynamically determined evaluation instructions at the identified plurality of agentic AI models;
determining, by the processor, one or more actions for claim adjudication using a stepwise reasoning path model and results of validation wherein the one or more actions comprise retrieving additional claim data, generating external application programming interfaces, and refining a policy evaluation;
generating, by the processor, a final claim result based on the stepwise reasoning path model and the determined one or more actions; and
outputting, by the processor, the final claim result and explanation data corresponding to the final result on the user interface of the user device, wherein the explanation data comprises at least one of references to the one or more insurance policy documents and the stepwise reasoning path model.

13. The method of claim 12, further comprises:
receiving, by the processor, multimodal external evidence data from one or more external data sources, wherein the multimodal external evidence data comprises at least one of social media activity data, geolocation data, public records data, and biometric log data associated with the claimant;
generating, by the processor, a trust graph representing behavioral relationships and physical relationships between the insurance-related data and the multimodal external evidence data using a multimodal evidence cross-correlation agentic AI model, wherein the trust graph comprises nodes representing at least one of activity level indicators, physical location patterns, claim detail entities, and cross-domain evidence entities obtained from the multimodal external evidence data; and
computing, by the processor, a Bayesian claim anomaly score representing a posterior probability of anomalous behavior indicated in the trust graph and a stepwise reasoning path generated by the reasoning agent using a Bayesian anomaly agentic AI model.

14. The method of claim 13, wherein to compute the Bayesian claim anomaly score, further comprises:
determining, by the processor, a deviation between policy-driven conclusions in the stepwise reasoning path and behavioral patterns encoded in the trust graph;
determining, by the processor, if the Bayesian claim anomaly score exceeds a predefined anomaly threshold value;
applying, by the processor, the Bayesian claim anomaly score at a decision junction to override the final claim result generated based on the stepwise reasoning path and based on the determined deviation, if the Bayesian claim anomaly score exceeds a predefined anomaly threshold value, wherein the override generates a modified final claim result comprising at least one of a denial, a flag for manual review, and an escalated approval requirement; and
generating, by the processor, override rationale data comprising an original stepwise reasoning path and a justification data for the Bayesian claim anomaly score.

15. The method of claim 12, wherein to extract the insurance‑related data from the input data using the first Generative Artificial Intelligence (Gen AI) model, further comprises:
generating, by the processor, one or more tokens corresponding to textual portions of the input data using the first Gen AI model, wherein the textual portions comprise at least one of free‑text treatment descriptions, provider notes, and claimant notes;
identifying, by the processor, entities corresponding to at least one of diagnoses, procedures, body parts, medications, and dates by determining at least one a named‑entity data in the generated one or more tokens;
mapping, by the processor, the identified entities to standardized diagnosis codes and procedure codes using one or more medical coding ontologies and based on the first Gen AI model;
parsing, by the processor, structured fields of the claim data, the claimant attributes, and provider information to obtain the structured claim attributes using the first Gen AI model, wherein the structured claim attributes comprise at least one of normalized codes, normalized amounts, and normalized dates;
determining, by the processor, the unstructured claim attributes using the first Gen AI model, wherein the unstructured claim attributes comprise at least one of an inferred severity, an inferred place of service, an inferred claim context, and narrative treatment descriptions from the textual portions; and
outputting, by the processor, the structured claim attributes and the unstructured claim attributes as the extracted insurance‑related data in an insurance‑related data object.

16. The method of claim 12, wherein to generate the sequence of dynamically determined evaluation instructions for adjudicating the insurance claim using the reasoning agent, further comprises:
generating, by the processor, a contextual query from at least a subset of the extracted insurance‑related data using the reasoning agent, wherein the contextual query comprises the diagnosis codes, procedure codes, and contextual claim attributes;
retrieving, by the processor, the one or more contextually relevant policy sections from the at least one policy database by applying the contextual query to the one or more insurance policy documents using the reasoning agent;
segmenting, by the processor, the retrieved one or more contextually relevant policy sections into a plurality of policy clauses using the reasoning agent, wherein each policy clause corresponds to at least one of a coverage condition, an exclusion, a limitation, and a medical necessity requirement;
determining, by the processor, a subsequent evaluation operation by applying a stepwise chain‑of‑thought reasoning process over the extracted insurance‑related data and the plurality of policy clauses using the reasoning agent;
generating, by the processor, an evaluation instruction corresponding to the determined subsequent evaluation operation, wherein the evaluation instruction comprises at least one of a policy clause identifier, a required input parameter, and an expected output parameter;
appending, by the processor, the generated evaluation instruction to the sequence of dynamically determined evaluation instructions; and
iteratively repeating, by the processor, the process of determining, generating, and appending until the policy interpretation steps required by the retrieved contextually relevant policy sections is being covered.

17. The method of claim 12, wherein to execute the sequence of the dynamically determined evaluation instructions by selectively applying the sequence at the identified plurality of agentic AI models, further comprises:
executing, by the processor, the identified agentic AI model with input parameters for each evaluation instruction, wherein the input parameters comprise at least a portion of the extracted insurance‑related data and intermediate results from previously executed evaluation instructions;
receiving, by the processor, an evaluation result as an output from the agentic AI model, wherein the evaluation result comprises at least one of a Boolean decision, a numerical value, a classification label, and an extracted data field;
updating, by the processor, a claim evaluation state database with the received evaluation result in association with the evaluation instruction; and
outputting, by the processor, the updated claim evaluation state database as a context to a subsequent evaluation instruction in the sequence.

18. The method of claim 12, wherein to validate the output of the identified plurality of agentic AI models based on the executed sequence of the dynamically determined evaluation instructions, further comprises:
aggregating, by the processor, evaluation results generated by each of the plurality of agentic AI models into a consolidated result set;
determining, by the processor, whether the evaluation results for each evaluation instruction satisfies one or more predefined consistency checks, wherein the one or more predefined consistency checks comprise at least one of range checks, type checks, and logical dependency checks;
detecting, by the processor, conflicts between the evaluation results corresponding to a plurality of evaluation instructions and prestored result corresponding to one of a similar policy clause and a similar claim attribute;
assigning, by the processor, a confidence score to each evaluation result based on at least one of a source agentic AI model type, a historical performance metric, and the detected conflicts; and
generating, by the processor, a validation result object indicating at least one of validated evaluation results, flagged evaluation results, and associated confidence scores.

19. The method of claim 12, wherein to determine the one or more actions for the claim adjudication using the stepwise reasoning path model and the results of validation, further comprises:
generating, by the processor, the stepwise reasoning path model representing nodes corresponding to the evaluation instructions and edges corresponding to dependencies between the evaluation results;
annotating, by the processor, the nodes of the stepwise reasoning path model with a validation result object, wherein the validation result object comprises validated evaluation results and flagged evaluation results;
identifying, by the processor, points in a stepwise reasoning path requiring information by traversing the stepwise reasoning path model based on a predefined traversal strategy;
determining, by the processor, the one or more actions for the claim adjudication at each of the identified points, wherein the one or more actions comprise at least one of retrieving additional claim data, generating external application programming interfaces (APIs), and refining a policy evaluation by regenerating and adjusting one or more evaluation instructions; and
generating, by the processor, an action plan for each determined action, wherein the action plan comprises an associated target data source, external API endpoint, and a condition for executing the action.

20. The method of claim 12, wherein to generate the final claim result based on the stepwise reasoning path model and the determined one or more actions, further comprises:
executing, by the processor, an action plan by performing the retrieval of additional claim data, generating the external APIs, and refining the policy evaluation until the stepwise reasoning path model indicates completion of required actions;
updating, by the processor, the stepwise reasoning path model to reflect results of the executed actions;
determining, by the processor, a claim disposition result comprising at least one of an approval, a denial, and a pending status based on a terminal state of the updated stepwise reasoning path model;
calculating, by the processor, a payable amount based on covered services, applicable deductibles, copayments, and coinsurance as indicated by the evaluation results represented in the stepwise reasoning path model; and
generating, by the processor, the final claim result comprising at least one of the claim disposition result and the calculated payable amount.
